(19) United States
(12) Patent Application Publication
(10) Pub. No.: US 2018/0131574 A1
(43) Pub. Date: May 10, 2018

(54) REMOTE SERVER MONITORING AND PATCHING SYSTEM

(71) Applicant: SingeHop, LLC, Chicago, IL (US)

(72) Inventors: Jordan M. Jacobs, Chicago, IL (US); Ricardo Talavera, JR., Burbank, IL (US); Marcus Hightower, Chicago, IL (US); Roger M. Wakeman, Chicago, IL (US); Aaron Ryou, Chicago, IL (US); Lukasz Tworek, Powell, OH (US); Samuel Bowling, Sioux Falls, SD (US); Andrew Brooks, Chicago, IL (US)

(21) Appl. No.: 15/347,245

(22) Filed: Nov. 9, 2016

(51) Int. Cl. H04L 12/24; G06F 9/445

(52) U.S. Cl. CPC H04L 41/14; H04L 67/10; G06F 8/65; H04L 41/08

(57) ABSTRACT

A system stored in a non-transitory medium executable by processor circuitry is provided for remotely monitoring and managing servers. In one embodiment, the system includes a plurality of servers having a plurality of operating systems. A plurality of monitoring and patching agents are installed on the operating systems of the plurality of servers and a central platform server is in operative communication with the plurality of monitoring and patching agents over a network. The plurality of monitoring and patching agents are configured to monitor performance data for the plurality of servers and to transmit the data to the central platform server over the network.

### CROSS-REFERENCE TO RELATED APPLICATIONS

This application claims the priority benefit of U.S. Provisional Patent Application Nos. 62/253,003 and 62/253,041, each filed Nov. 9, 2015, U.S. Provisional Patent Application No. 62/260,278, filed Nov. 26, 2015, U.S. Provisional Patent Application No. 62/260,703, filed Nov. 30, 2015, and U.S. Provisional Patent Application No. 62/323,242, filed Apr. 15, 2016, each of which are incorporated herein by reference, except that in the event of any inconsistent disclosure or definition from the present specification, the disclosure or definition herein shall be deemed to prevail.

### BACKGROUND OF THE INVENTION

### 1. Field of the Invention

The present disclosure relates generally to server management, and more particularly, to systems and interfaces for intelligently monitoring and managing network servers.

### 2. Description of the Background of the Invention

Data centers are physical facilities which generally house a large group of networked computer servers (assets) typically used by organizations for the remote storage, processing, or distribution of large amounts of data. Data center customers may typically own a large group of these networked computer servers (assets). The networked computer servers are typically used by the data center customers for the remote storage, processing, or distribution of large amounts of data. The data center customers pay the data center owner for supporting and managing the servers at the data center and providing enterprise connectivity. Thus, the data center owner is typically responsible for monitoring and managing a large number of networked computer servers, and in many cases, these networked computer servers may be housed at multiple geographic locations. The sheer number of networked computer servers and disparate geographic location of the servers often makes individual monitoring impractical.

Additionally, data centers and networked computer servers often require patching in order to improve overall performance and functionality. However, efficient patching is made difficult by the fact the networked computer servers, and especially those at disparate geographic locations, often have distinct operating systems and server configurations. This makes remote monitoring and manipulation of those servers arduous as the data center owner needs to account for each of these different operating systems and server configurations. Often, the only solution in the art for patching or updating servers is to isolate the servers having particular configurations and utilize a technician to apply patches manually to each server or each set of servers sharing identical characteristics. This requires a patching system that is separate and distinct from any means of any solution for monitoring or managing servers.

Moreover, such methods also suffer from the drawback that they do not provide a means for monitoring how a particular patch effects the operation and efficiency of a particular. Given that the servers often have different operating systems and configurations, a particular patch may be have beneficial implications to one set of servers, but negatively impact the function of an additional set. There is a need in the art for a single system that allows for intelligently monitoring on a large set of networked computer servers (including those having distinct operating systems and which are located at separate geographic locations) and for making intelligent recommendation for remedying the problem, such as by applying a particular patch and/or software update given the unique characteristics and state of a respective server. Additionally, there is a need for a system that individually monitors the networked computer servers after a patch or software update has been applied to determine the effect of the patch or software update.

### SUMMARY OF INVENTION

The present description discloses a system for intelligently monitoring and managing networked computer servers. According to certain embodiments, the system beneficially is implemented in a single application that provides for remote monitoring and management of a large set of networked computer servers and provides the ability to remotely apply patches and software updates to the networked computer servers even though those networked computer servers may have distinct operating systems and may be located at different geographic locations. In this way, the system beneficially allows for the realization of enhanced monitoring and management for data center owners and increased savings for data center customers.

In one or more embodiments, a system for intelligently monitoring and managing networked computer servers is disclosed that has cross-platform capability. In one aspect of the system, a high level management feature allows the system to interface with a broad variety of servers having different operating systems and different web server applications. The system unifies operating system environment and works on any server regardless of where the server resides, e.g., whether the server is on premise, co-located, hosted, bare metal, virtual, or cloud based. The high level management feature also allows the system to detect both the operating system and the particular applications installed on each server for monitoring purposes and management purposes such as installation of updates and execution of particular commands (e.g., server restart). The flexibility of the disclosed system allows users to easily manage servers leased from multiple different vendors without being limited to a particular vendor and without being limited to a particular monitoring and/or management system associated with one vendor.

In another aspect, the system implements a graphical user interface that provides a single access point for users to log in and monitor and manage their servers, regardless of the vendor hosting the server. For example, a single user may have servers located and operated by two different vendors, e.g., AMAZON® and IBM®. The servers operated by AMAZON® could use a different operating system than the servers operated by IBM®. The disclosed system provides an online access point to the high level management feature that allows the user to monitor all of its servers at different locations and in data centers that are operated by different vendors, and also allows the user to monitor important attributes about those servers in order to determine how the servers performing (e.g., CPU and memory status) irrespective of the particular operating system on the particular servers. In another aspect, the system provides the user with alerts for particular servers, such as the need for updates for one or more applications on a particular server. In certain embodiments, the customer can use the interface implemented by the system to install the update on a particular server and to monitor how the update affects the performance of that server.

In certain embodiments, the system implements a monitoring subsystem together with a patching subsystem within a single, complete system that allows a user to leverage the monitoring and management capabilities of the system to manage day-to-day operations, such as patching processes, software or firmware updates, and system roll-backs. In addition, the combination of a monitoring and management system provides users easier access to the services needed to operate networked computer servers in a single tool. Beneficially, users may utilize the disclosed system to monitor, manage, report, receive alerts, install updates, configure operating parameters, roll-out additional features, and train all from within a single networked solution. Furthermore, the integration of these features within a single system further reduces operating cost, and mitigates risk associated with loss of services due to failed and/or underperforming servers.

In one aspect, the patching subsystem provides various ways to reverse installed patches when the monitoring subsystem determines that a server is failed and/or underperforming. For example, the system may include one or more routines for (1) restoring a server image; (2) executing a particular patch uninstaller; (3) replacing individual files modified at the time of patch installation with copies of those files made prior to the patch installer commencing its operation; and (4) executing a series of targeted modifications to files located on the server to increase sever performance. In certain embodiments, the graphical user interface provides alerts when a server is failed and/or underperforming, and implements interface elements that allow the user to select the server and perform a corresponding action, such as reversing installed patches.

In additional embodiments, the system also implements server discovery feature that allows the system to identify new servers within a production server farm so that the user may ensure that all servers are the subject of monitoring and patching as needed. As servers come online, the system may discover those servers which are not yet enrolled in monitoring and present a listing of those servers which may be candidates for monitoring to the user. The system can then remotely install a monitoring and patching agent on the new server, or connect the server to an existing monitoring and patching agent. This helps to ensure that systems which are determined by the user to provide critical business processes are not inadvertently overlooked for enrollment.

In another aspect, the system also allows a user to utilize the graphical user interface to monitor and assign issues that need to be resolved. For example, the graphical user interface may display alerts when a server is failed and/or underperforming as well as a recommendation for remedying the problem, such as by applying a particular patch and/or software update given the unique characteristics and state of a respective server. The user may utilize the graphical user interface to claim a problem as his to resolve (e.g., patch on his own) or to assign the problem to another user within the corporation or a third-party service provider to assess and resolve the problem. Additionally, in some embodiments, the system may track activity of users that have previously solved issues and store this information in a user profile along with additional data. The additional data may include a number of data points, such as the users' geographic location, their company role, and their varying levels of expertise with particular server issues and/or the unique characteristics and state of a respective server. The system can make intelligent recommendations regarding which users are best suited to the fix particular problems based on factors such as a user's expertise, prior tasks solved, or their familiarity with a particular server configuration, such as its operating system or whether the server is on premise, co-located, hosted, bare metal, virtual, or cloud based.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 is an exemplary display for implementing a graphical user interface according to certain embodiments that displays a dashboard summary of activity within the server management system.

FIG. 2 is an exemplary display for implementing a graphical user interface according to certain embodiments that displays information for the server inventory list being monitored and managed by the system.

FIG. 3 is an exemplary display for implementing a graphical user interface according to certain embodiments that displays information for action items for the server inventory being monitored and managed by the system.

FIG. 4 is an exemplary display for implementing a graphical user interface according to certain embodiments that displays service monitoring information for the server inventory.

FIG. 5 is an exemplary display for implementing a graphical user interface according to certain embodiments that displays port monitoring information for the server inventory.

FIG. 6 is an exemplary display for implementing a graphical user interface according to certain embodiments that displays patching information for the server inventory.

FIG. 7 is an exemplary display for implementing a graphical user interface according to certain embodiments for displaying and issuing remote execution commands to particular services within the server inventory.

FIG. 8 is an exemplary display for implementing a graphical user interface according to certain embodiments for displaying support case and case management information for servers being monitored and managed by the system.

FIG. 9 is an exemplary display for implementing a graphical user interface according to certain embodiments for displaying detailed management information for a particular support case.

FIG. 10 is an exemplary display for implementing a graphical user interface according to certain embodiments for displaying and managing user information.

FIG. 11 is an exemplary display for implementing a graphical user interface according to certain embodiments for displaying and managing user's role data.

FIG. 12 is a flowchart illustrating an exemplary system and method for adding or importing a server into the monitoring and management system.

FIG. 13 is a block diagram of an exemplary network environment in which the remote monitoring and management system operates.

FIG. 14 is a block diagram of an exemplary embodiment of the artificially intelligent environment in which the remote monitoring and management system operates.

FIG. 15 is a block diagram of an exemplary embodiment of the artificially intelligent environment for deploying monitoring and patching agents.

FIG. 16 is a block diagram of an exemplary embodiment of the artificially intelligent environment for deploying a dedicated artificially intelligent server at a place of business

FIG. 17 is a block diagram of an exemplary embodiment of the artificially intelligent environment for monitoring and managing servers.

FIG. 18 is a flowchart illustrating an exemplary system and method for detecting and enrolling new servers and operating systems to be monitored and managed by the system.

FIG. 19 is a flowchart illustrating an exemplary system and method for installing monitoring and patching agents on an operating system using an enhanced one-line-command installation process.

FIG. 20 is a flowchart illustrating an exemplary system and method for reversing a previously applied patch or software update.

FIG. 21 is a block diagram of an exemplary embodiment of the AI environment for detecting new software updates and intelligently applying patches.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrases “in another embodiment” or “in further embodiments” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors.

By way of introduction, systems and methods in accordance with the present description provide for, among other applications, an innovative means to (a) monitor and manage a plurality of servers having different operating systems and different server configurations using an innovative monitoring and patching agent that can customized to run on or interface with distinct operating systems and server configurations, (b) provide a graphical user interface that allows a user to quickly review performance data for the monitored and managed a servers, as well as receive alerts when performance falls below set thresholds, execute commands to update or modify server configurations, manage employee roles, and assign tasks to be completed by the employees or third-party technicians, among other features, (c) automatically apply patches and software updates to particular sets of servers, such as those servers having a particular operating system or server configuration, (d) review performance data for updated servers to receive alerts when patches or software updates have negatively impacted server performance, and (e) reverse patches or software updates using a number of different techniques that can be customized to a particular subset of server having a specific operating system or configuration, such as restoring server images, executing a customized uninstaller program, or performing a series of file modifications that can be customized to the specific operating system and server configuration.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

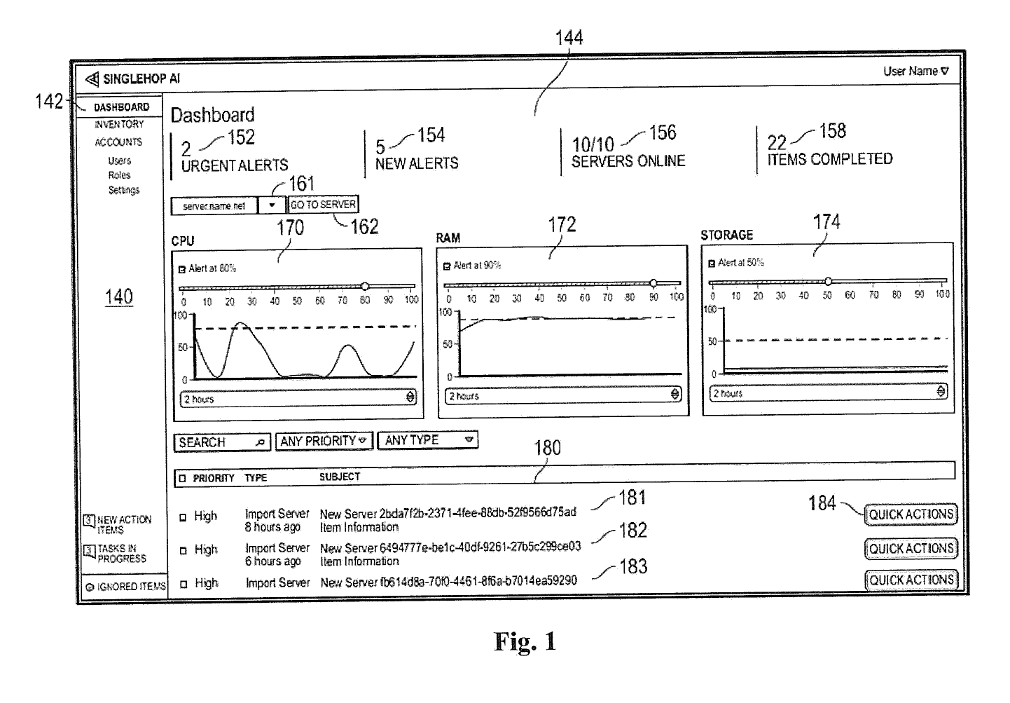

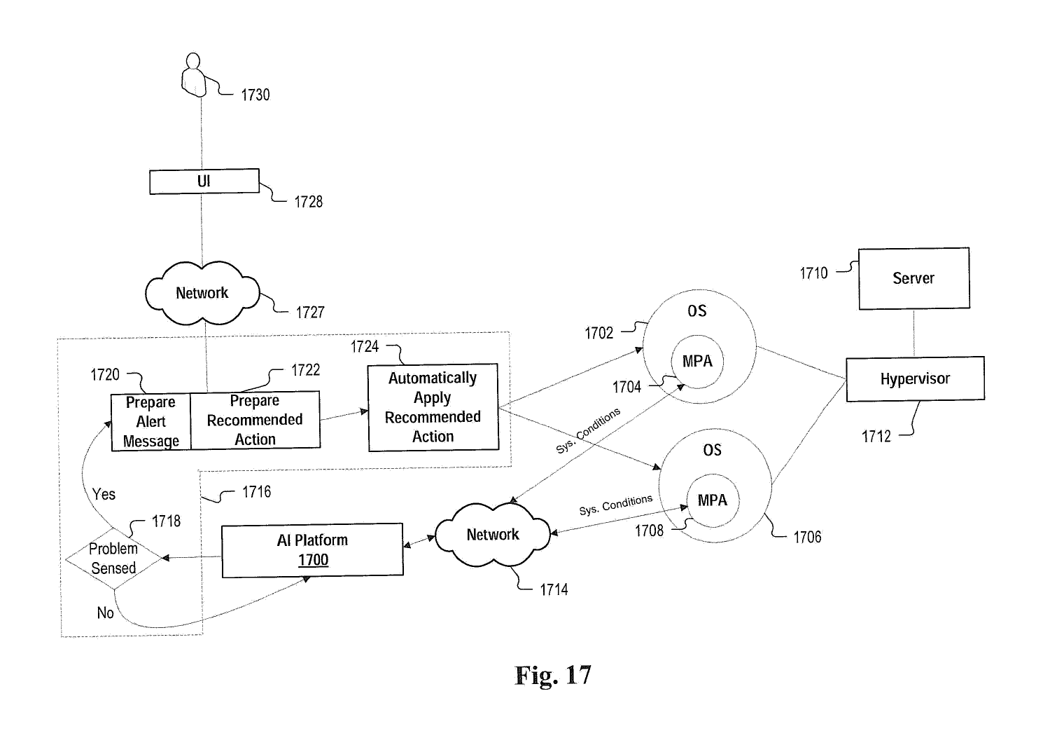

Referring now to the figures, FIG. 1 an exemplary display for implementing a graphical user interface according to certain embodiments that displays a dashboard summary of activity within the server management system. The dashboard display of the embodiment depicted in FIG. 1 shows a user interface dashboard having multiple views, including a panel area 140 containing various interface elements that may be selected by the user and a main view 144 that displays a set of information in response to a user selection of one the elements in the panel area 140. For example, when a user selects dashboard link 142 in the panel area 140, a general overview of information related to the server management system is displayed in the main viewing area 144. This dashboard view allows users to view and manage important information related to the operation of various serves currently being monitored by the system. In one embodiment, the main viewing area 144 of the graphical user interface will display summary information near the top of the dashboard display that quickly informs the user on the number of urgent alerts 152, new alerts 154, servers online 156, and items completed 158 for the servers being monitored and managed by the user. A user can view a specific server by selecting the server's name by, for example, using the drop-down server selection menu 161 to locate and highlight the server's name and pressing go to server 162. As shown in FIG. 1, selecting the server's name will cause the main viewing area 144 to display summaries of various processing parameters related to the selected server being managed by the system, such as graphs, percentages, or other visual elements depicting the current CPU usage 170, RAM usage 172, and storage usage 174. In the embodiment shown in FIG. 1, this information is displayed as a percentage alongside a graph that depicts the usage statistics for the server currently selected in the drop-down server selection menu 161. In the embodiment shown in FIG. 1, the main view area 144 also displays action items 180, which show important information about servers 181, 182, and 183, such as the outstanding tasks to be completed for those servers and the priority level for each task. In some embodiments, the interface allows the user to resolve the action item by selecting an from the quick actions drop down menu 184, which may include, for example, Go to Server Detail, Assign to My Team, Assign to Company, Apply Patch, Schedule Patch, Remind Me Later, or Ignore. For example, if the issue listed in action items 180 is that a new patch has been released, then the user may use quick action 184 to select a process for applying the patch, as described further in connection with FIGS. 17-21, for example.

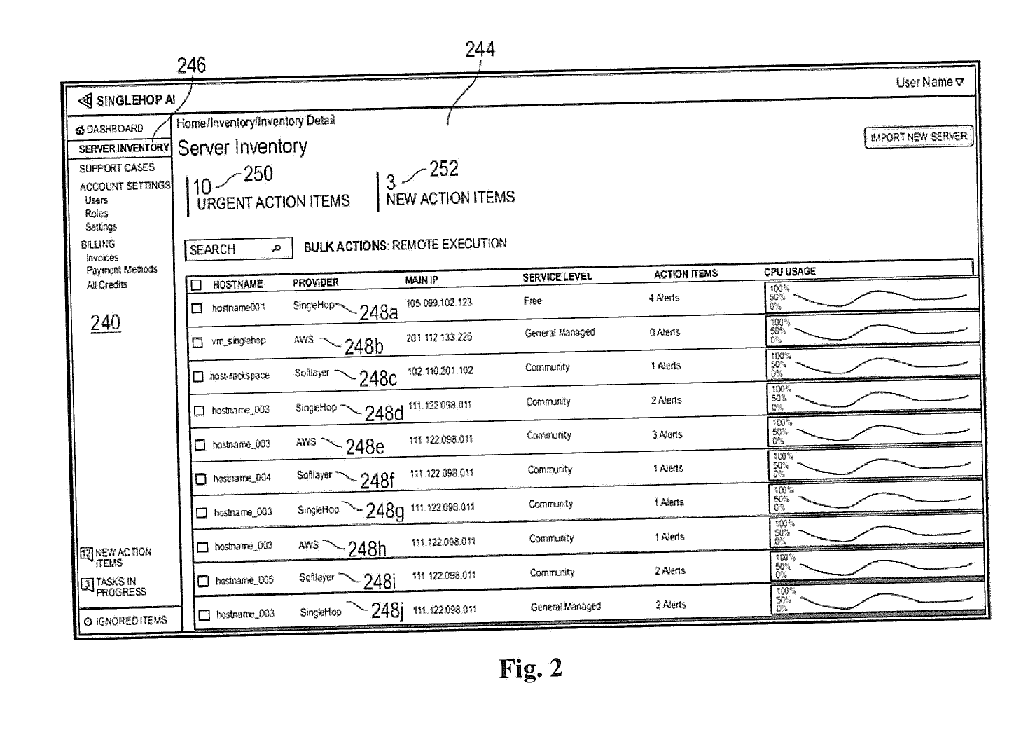

Referring now to FIG. 2, an exemplary display for implementing a graphical user interface according to certain embodiments is shown for displaying information for the server inventory list being monitored and managed by the system. As shown in FIG. 2, a user has selected the server inventory list in panel area 240, and in response to the user's selection, the main viewing area 244 displays information for the server inventory list being monitored and managed by the system. When a user selects server inventory 246 in the dashboard 240, the various customer servers 248a-j are displayed in the viewing area 242. Details about each server are also displayed in the viewing area 242, such as hostname, provider, IP address, service level, action items, and a low detail CPU usage graph.

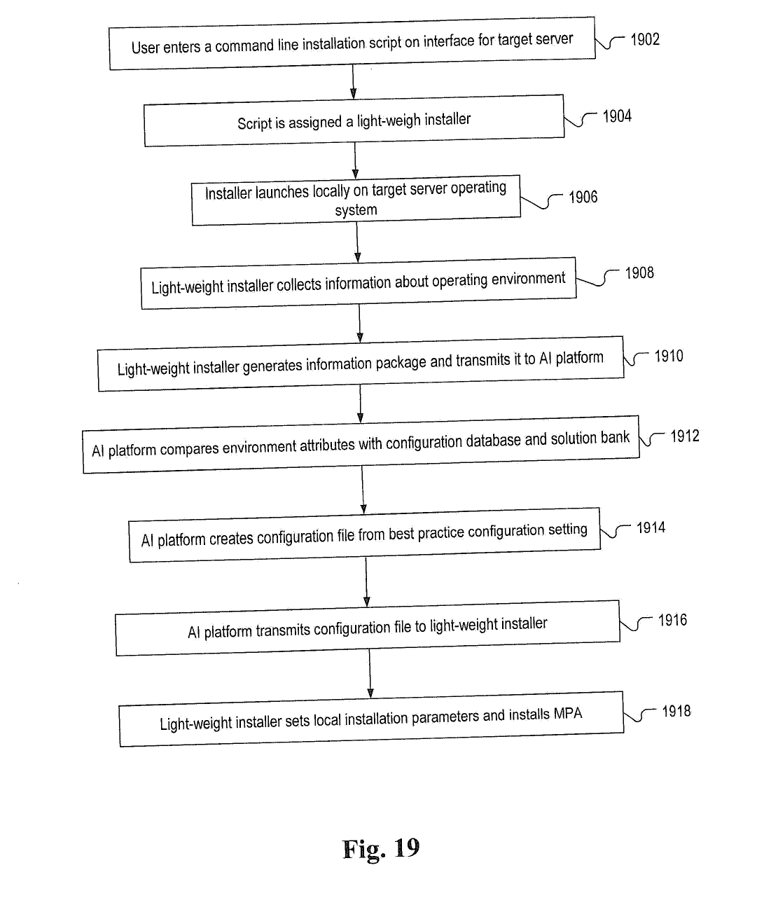

Also displayed in the viewing area 242 is a summary of urgent action items 250 and new action items 252, as well as an interface element for importing new server 254. Selecting the import server 254 element allows users to easily install the remote monitoring platform on any server from any provider, as described further in connection with FIG. 19, for example. In one embodiment, urgent action items 250 and new action items 252 display notification information that is tailored by the system to the specific user logged into the system and that user's core job roles. For example, the system may utilize the user's profile information to determine which items are most relevant to the particular user and display a summary of those action items when the user views the set of server inventory.

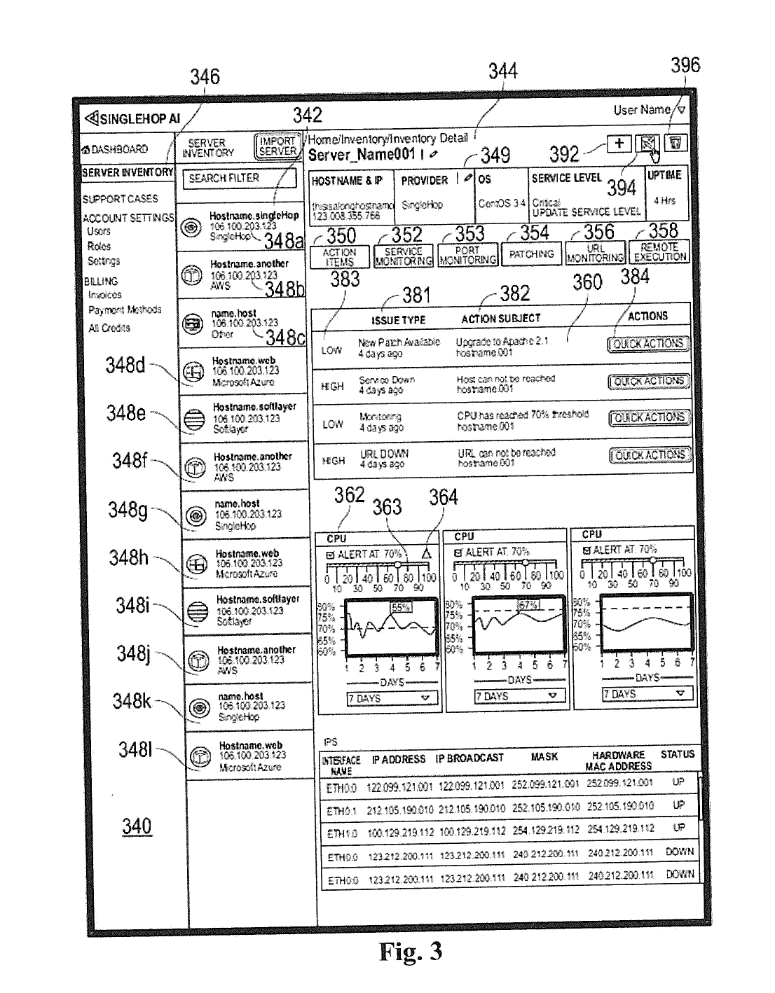

Referring now to FIG. 3, an additional display for implementing a graphical user interface according to certain embodiments is shown for displaying action item information for the server inventory being monitored and managed by the system. As shown in FIG. 3, when a user selects the server inventory 346 interface element in the dashboard 340, the system displays data in the viewing area 342 related to the customer servers 348a-1 that are being monitored and managed by the system. When a user selects one of the customer servers, such as customer server 348a, the system displays the customer server information 349 in the main view 344, including general details about the customer server operation such as IP address, ISP, operating system, and uptime.

The system also allows the user to utilize main view 344 to explore various details of customer server 348a, such as information related to action items 350, service monitoring 352, port monitoring 354, patching 356, URL monitoring 358, and remote execution 360. In some embodiments, the interface elements associated with action items 350, service monitoring 352, port monitoring 354, patching 356, URL monitoring 358, and remote execution 360 may be individually selected to display information related to that topic. As shown in FIG. 3, the action item 350 interface element is selected, and information related to outstanding action items is displayed in the viewing area 360. In certain embodiments, the outstanding action items include pre-defined, actionable notifications that are relevant to users and their core job roles. These may include items such as Support Case/New Support Case, Support Case Reply, New Server, New Patch, Monitoring Alert (CPU), Monitoring Alert (RAM), Monitoring Alert (Storage), Service Down, URL Down, and Port Down. The system circuitry monitors the managed servers for issues related to each of these action items and displays any relevant information related the action item on the graphical user interfaces for the respective monitored server.

When a user selects the action items interface element 350, information is displayed such as a list of various issue types 381 and action subjects 382. Each issue type 381 may have a priority ranking 383 such as low priority and high priority. In the embodiment shown in FIG. 3, the issue type 381 includes “service down” which is marked high priority, and “new patch available” which is marked as low priority. Each of the issue types 381 can also have an associated action subject 382 displaying the identified in greater detail. Each issue type 381 also has a corresponding quick action command 384 for the user to address the particular issue. The quick actions for a particular issue will be tailored by the system to that particular issue and may include Go to Server Detail, Assign to My Team, Assign to Company, Apply Patch, Schedule Patch, Remind Me Later, or Ignore, among others. For example, if the user wishes to address issue the first issue of“new patch available,” then the user may select the corresponding quick action 384 will cause the system to the guide the user through the patching process, as described further in connection with FIGS. 17-21, for example.

Additionally, the embodiment shown in FIG. 3 also displays additional summary information related to the CPU usage, RAM, and storage details for the selected server (here, customer server 348a). Beneficially, the system circuitry continuously monitors performance measurements for the managed servers (such as the CPU usage, RAM, and storage details) and displays alerts or notifications for when one of these performance measurements has reached a critical level or is outside of standard operating procedures. In certain embodiments, the user may select an alert level or specified threshold for each of the performance measures and the system will display the alert or notification when the particular performance measure exceeds the selected value. For example, in the embodiment shown in FIG. 3, the user has selected an alert value 363 of 70% for CPU usage. When the system detects that the CPU usage has exceeded that value, then it will display the alert or notification to the user in one of a number of ways, such as by including the alert information on the user's dashboard, sending the user an email or other message, or displaying a visual indicator on the relevant graphical user interface displays that show information related to the server. In the embodiment shown in FIG. 3, the system displays an alert icon 364 and colored alert box 362 around the server's CPU usage information.

The embodiment shown in FIG. 3 also includes additional interface elements in the main view 344 that are associated with additional actions, such as add a server 392, edit a server 394, and delete server 396.

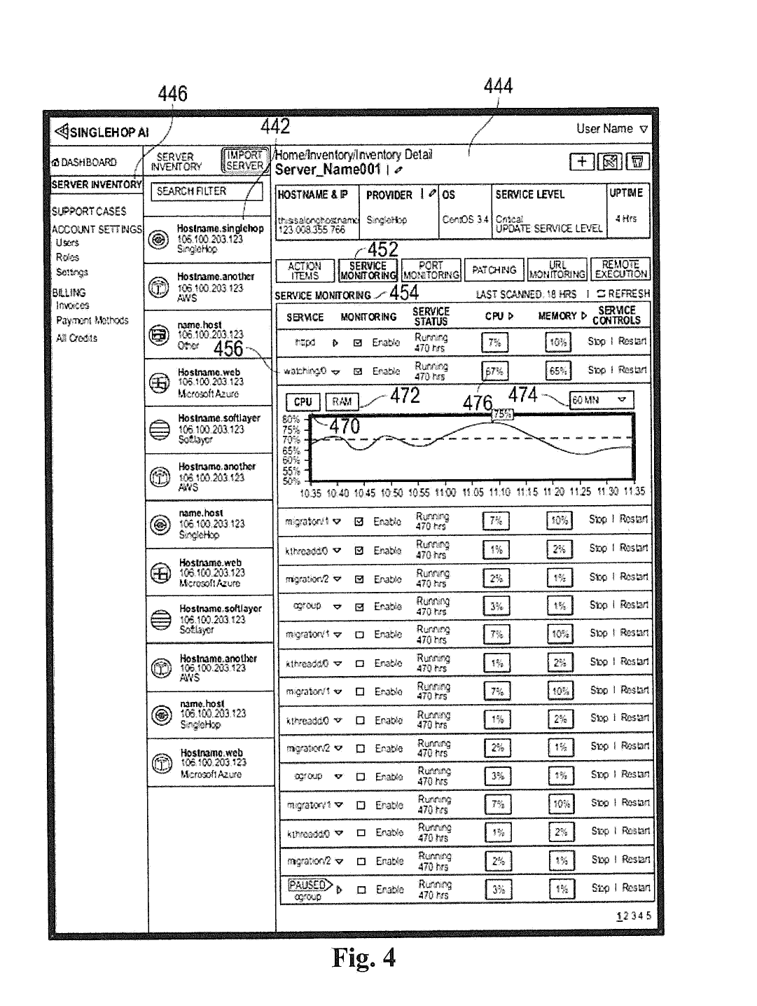

Referring now to FIG. 4, a display for implementing a graphical user interface according to certain embodiments is shown for displaying service monitoring information for the server inventory. As shown in FIG. 4, the user has again selected the server inventory list 446 and the system is displaying data in the viewing area 442 related to the customer servers that are being monitored and managed by the system, as well as additional information for the selected customer server in main view 444, including general details about the customer server such as IP address, ISP, operating system, and uptime, as described further in connection with FIG. 3.

In the display shown in FIG. 4, the user selected the service monitoring 452 interface element and the display area 454 now displays a list of services 454 being monitored for the particular customer server. In some embodiments, the system can be configured to monitor one or more services for each of the managed customer servers. The details on the service being monitored can be accessed using the interface shown in FIG. 3, and the graphical user interface will display summary information the particular servers' monitored services, such as the service's name, whether it's being actively monitored, the service's status, CPU usage, memory usage, and controls to stop or restart it. In certain embodiments, clicking an individual service, such as service 456, will cause the display a drop down summary of information related to that service, such as CPU usage or RAM usage over time. In the embodiment shown in FIG. 4, the user may select the CPU usage 470 interface element (or the RAM usage 472 interface element) and the selected period of time from drop menu 474 to cause the system to display a graph of the service's usage during the selected time period. A summary of each service's usage data (regardless of whether the particular service is selected) is also displayed as a usage icon 476 for each monitored service, and this information may be updated in real-time for each monitored service. In application, each server can have numerous services being monitored, including various processes, applications, software routines, performance metrics (such as memory, CPU, and RAM usage, etc.), and any other information that the central platform may wish to monitor and manage to ensure that the servers are operating properly and efficiently. Therefore, one benefit of the service monitoring feature 452 is that the system allows a complete customization of services being monitored and the usage details for each service is displayed in easily managed fashion.

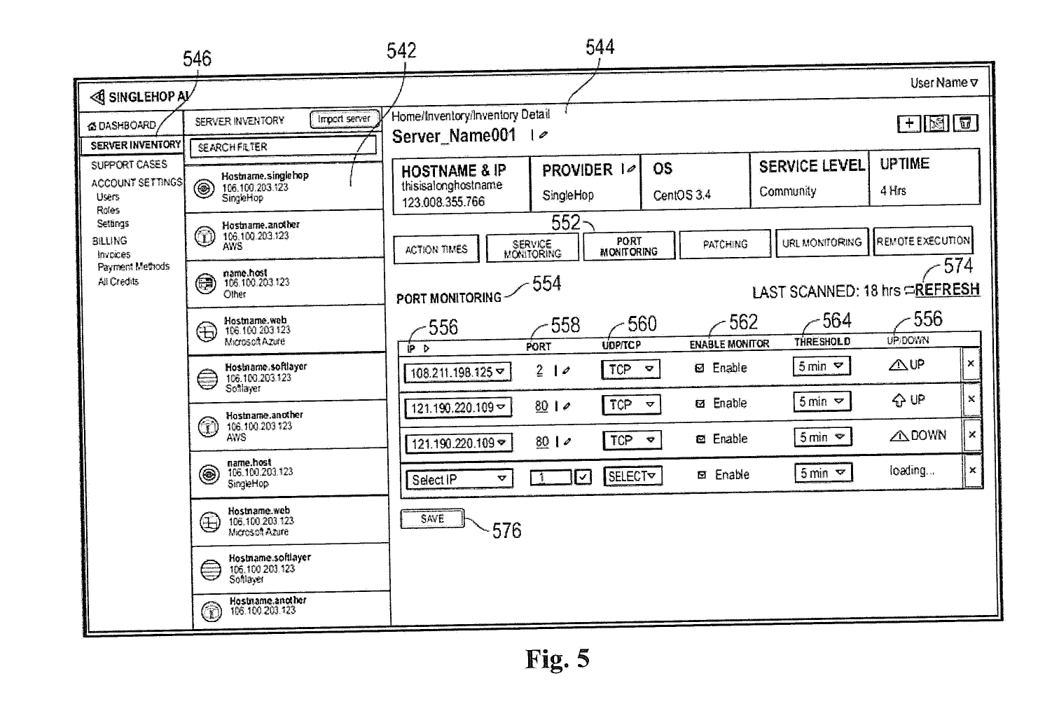

Referring now to FIG. 5, a display for implementing a graphical user interface according to certain embodiments is shown for displaying port monitoring information for the server inventory. As shown in FIG. 5, the user has again selected the server inventory list 546 and the system is displaying data in the viewing area 542 related to the customer servers that are being monitored and managed by the system, as well as additional information for the selected customer server in main view 544, including general details about the customer server such as IP address, ISP, operating system, and uptime, as described further in connection with FIGS. 3 and 4.

In the display shown in FIG. 5, the user selected the port monitoring 552 interface element and the display area 554 now displays a list of ports 554 being monitored for the particular customer server. As explained further in connection with FIG. 4, each of the customer servers monitored by the system can have multiple services or processes running on it, and each service of process may use IP addresses and port numbers. When the user selects the port monitoring 552 interface element, the display area 554 lists information for each monitored service, including IP addresses 556 port numbers 558, transmission protocol 560, whether it is being monitored 562, the threshold refresh rate for monitoring 564, which may be changed by the user using the respective drop down menu, and whether the server is up or down 466. In some embodiments, this information may update in real-time or periodically at set intervals, or the table can be manually refreshed by clicking the refresh button 574. The user may utilize the graphical user interface to modify the variables for a given service, such as the port number, and click the save button 576 to populate all changes to the system.

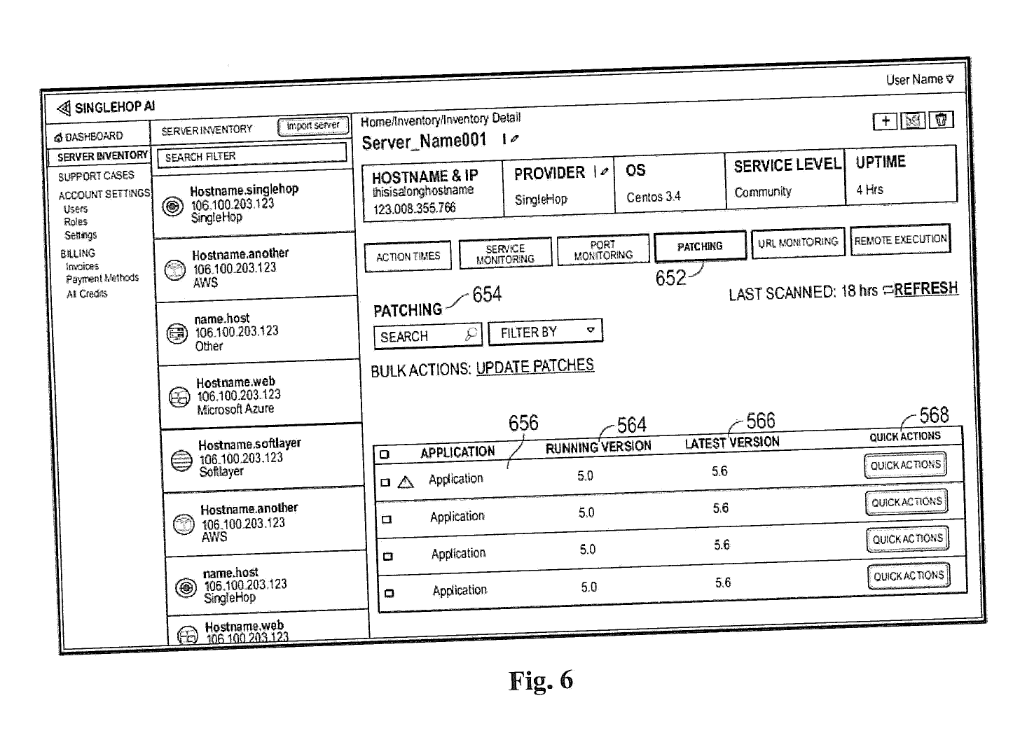

Referring now to FIG. 6, a display for implementing a graphical user interface according to certain embodiments is shown for displaying patching information for the server inventory. In the display shown in FIG. 6, the user has selected the patching 652 interface element and the display area 654 now displays a list of patches 654 that may be applied to the selected customer server. Each of the customer servers monitored by the system can have multiple services or processes running on it, and the particular services or processes may vary from server to server. Moreover, each server may have distinct configurations, such as its provider 630 operating system 632 or whether the server is on premise, co-located, hosted, bare metal, virtual, or cloud based. Thus, there is a need to monitor the particular server configurations and account for the various patches that may be need to be applied. Each patch may affect a particular server configuration differently, so the user may beneficially utilize the patching 652 interface element along with the service monitoring and other elements to monitor the performance level of each server and determine which patch to apply the particular server.

As shown in FIG. 6, selecting the patching 652 interface element causes the system to displays a list of applications 656 for a specific server. Alongside each application, the system also displays the applications current version 564, the newest available version 566, and quick actions 568 users can take for each application, such as updating the application, assigning a task associated with the application to a particular, user, team, or third party contractor, applying a patch, scheduling a patch to applied at a later time, setting a reminder, or ignoring an alert associated with the application.

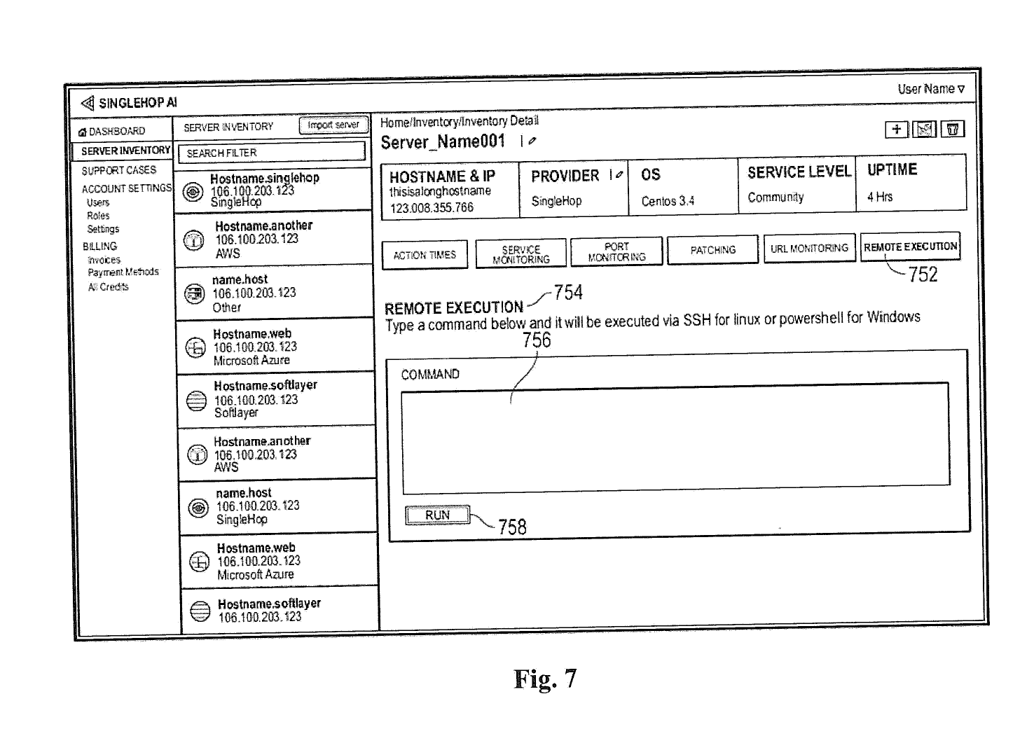

Referring now to FIG. 7, a display for implementing a graphical user interface according to certain embodiments is shown for displaying and issuing remote execution commands to particular services within the server inventory. In the display shown in FIG. 7, the user has selected the remote execution 752 interface element and the display area 754 now displays a command text box 756 for issuing commands to servers remotely execute tasks on the selected customer server. In certain embodiments, users can type commands into the command text box 756 and then select the run button 758 in order to execute the typed commands on the server using, for example, Secure Shell (SSH) for LINUX® or PowerShell for WINDOWS®.

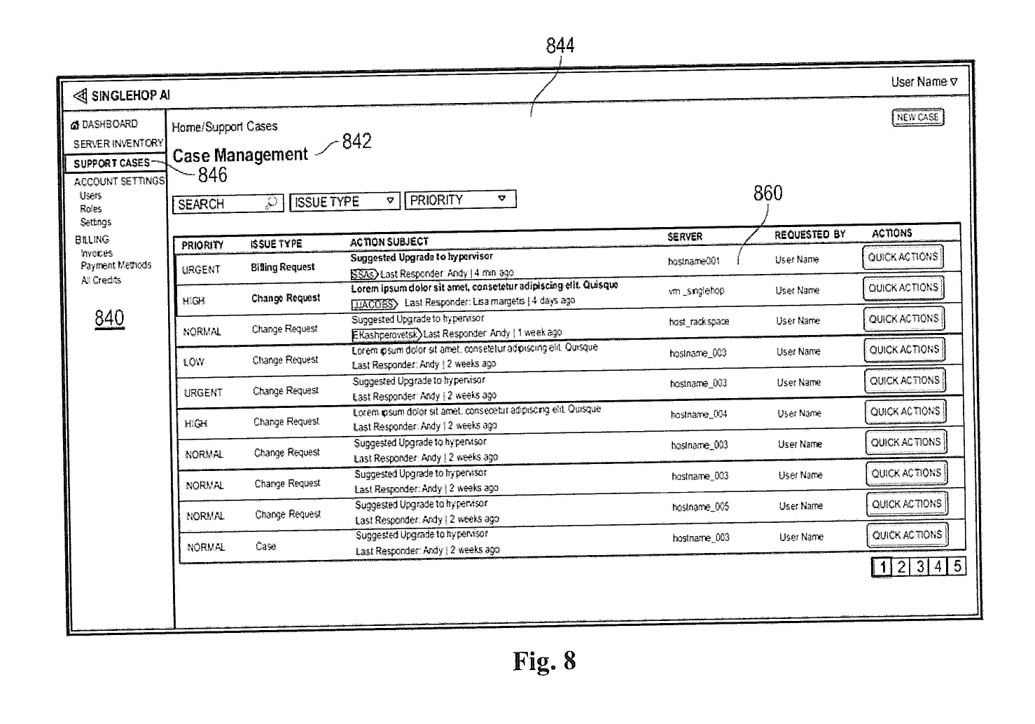

Referring now to FIG. 8, a display for implementing a graphical user interface according to certain embodiments is shown for displaying support case and case management information for servers being monitored and managed by the system. As shown in FIG. 8, when a user selects the support case 846 interface element in the dashboard 840, the system displays case management data 842 in the main viewing area 844 related to the support cases and tasks that are being monitored and tracked. Details about each support case are displayed in the viewing area 860, such as priority, issue type, action subject, server, requested by, and quick actions.

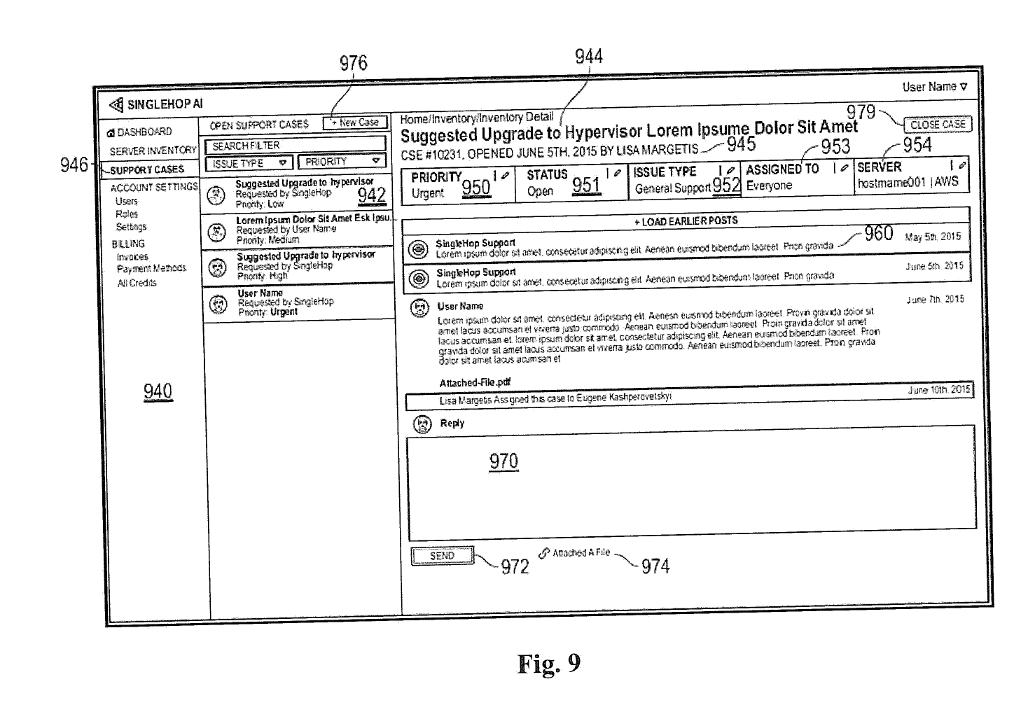

Referring now to FIG. 9, a display for implementing a graphical user interface according to certain embodiments is shown for displaying detailed management information for a particular support case. When the support case 946 interface element has been selected in the dashboard 940, as described further in connection with FIG. 8, the system displays the various support cases in the viewing area 942, as well as a detailed view for the selected support case in the main viewing area 944. The displayed information includes general details 945, such as case number, date created, and name of creator. The main view 944 also displays interface elements that allow the user to view and edit various attributes for the support case, such as priority 950, status 941, issue type 952, assigned to 953, and server 954. The main view 944 also displays a list of all of the communications and actions related to the support case in the post viewer 960. Individual posts are ordered by date and are expandable in the post viewer 960 by selecting the respective post. The post view area 960 also allows the user to reply to posts by typing a message into the reply window 970 and clicking send 972. Users can attach a file 974 to assist with resolving support cases. New cases can be created using by clicking the new case button 976 and existing cases can be closed by clicking the close case button 979.

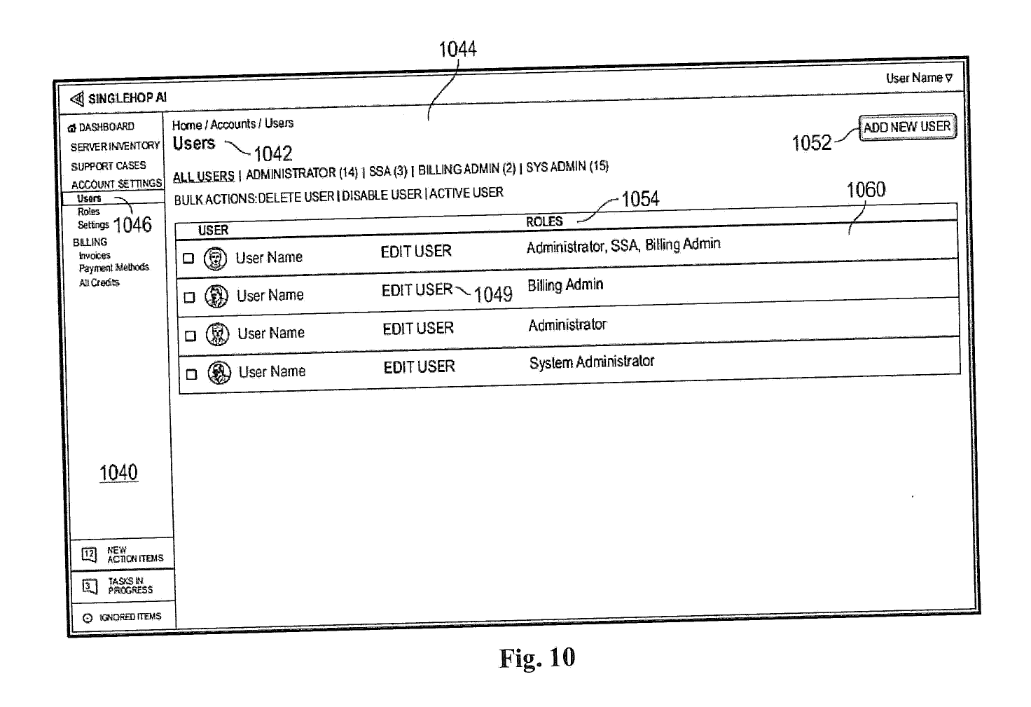

Referring now to FIG. 10, a display for implementing a graphical user interface according to certain embodiments is shown for displaying and managing user information. As shown in FIG. 10, when a user selects the users 1046 interface element under account settings in the dashboard 1040, the system displays data in the main viewing area 1044 related to the list of users 1042 associated with the customer's account. System administrators can use the interface shown in FIG. 10 to edit users 1049, such as by deleting or disabling the user, or add a new user 1052. The system administrators can also use the edit user 1049 feature to assign each user a specific a role 1054, or generate additional profile information that can be used by the task management system. Additionally, assigned roles control access and permissions to resources or functionality in the program.

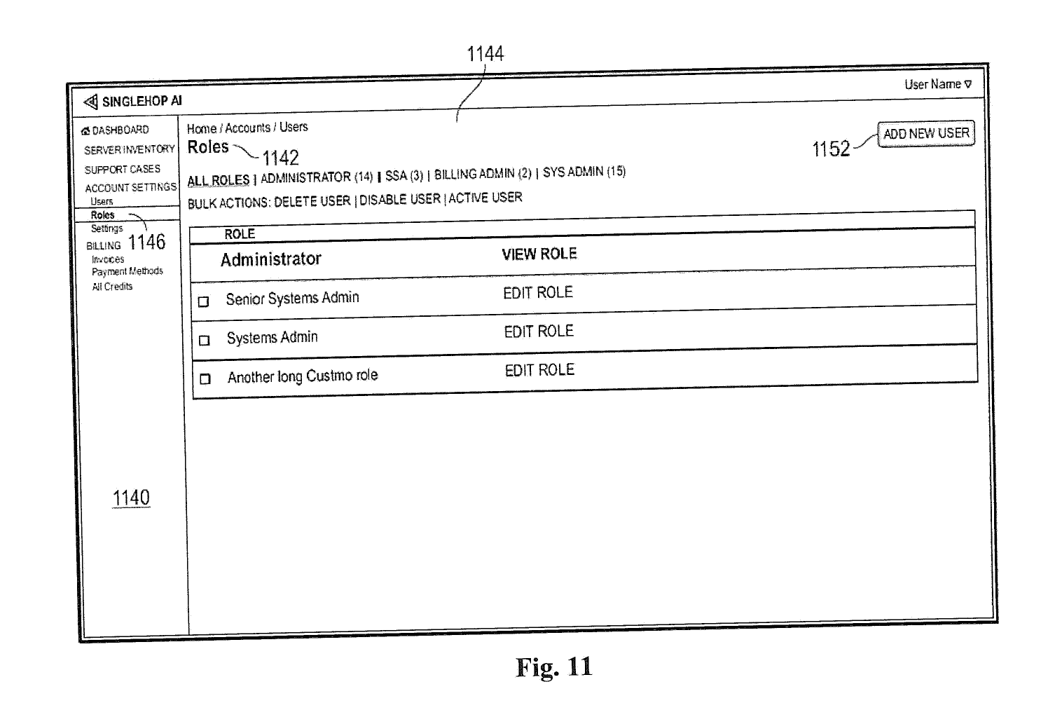

Referring now to FIG. 11, a display for implementing a graphical user interface according to certain embodiments is shown for displaying and managing user roles. As shown in FIG. 11, when a user selects the roles 1146 interface element under account settings in the dashboard 1140, the system displays data in the main viewing area 1144 related to the roles 1142 of users associated with the customer's account. Similar to as described in connection with FIG. 10, the interface shown in FIG. 11 allows the system administrator to implemented Role Based Access Control (RBAC), that simplifies the administration of user accounts and permissions by granting or denying access to resources or functionality based on role, as opposed to the individual user.

As will be apparent to one of ordinary skill in the art, the depicted interfaces in FIGS. 1-11 are exemplary and non-limiting, and modifications may be made without departing from the spirit and scope of the present disclosure.

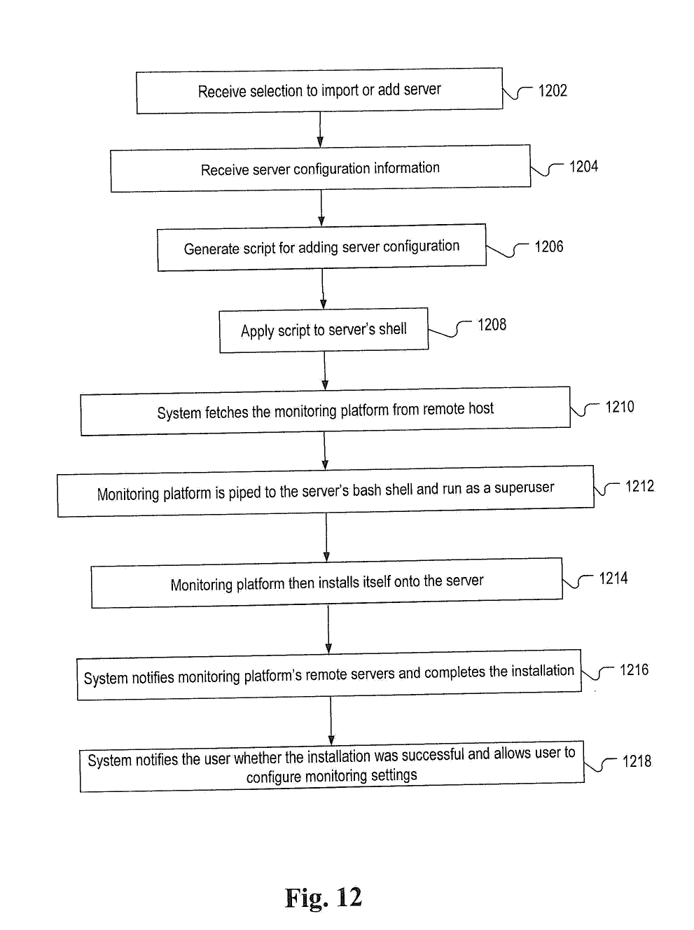

Referring now to FIG. 12, is a flowchart illustrating an exemplary method for adding or importing a server into the monitoring and management system. At step 1202, the system circuitry receives a selection, such as by a user or a system process, to import or add a new server to the remote monitoring and management system and processes the request. At step 1204, the system circuitry receives the server configuration, which may include, for example, the server's operating system or whether the server is on premise, co-located, hosted, bare metal, virtual, or cloud based. The system may receive this information directly from a user, or may issue one or more command prompts to the server to determine its configuration settings. At step 1206, the system circuitry generates a script or shell command for adding a server to the remote monitoring and management system. In some embodiments, the command may be a Linux web get (WGET) command and at step 1210 the system may use the command to fetch a monitoring platform (such as a remote monitoring and patching agent) from an AI platform. At step 1212, the monitoring platform is then piped to the server's bash shell and run as a superuser. At step 1214, the monitoring platform then installs itself onto the server. At step 1216, after the installation of the monitoring platform, the system will notify the AI platform that the installation has been complete and that the server is registered with the system. At step 1218, the system notifies the user whether the installation was successful. The notification may include one or more graphical user interface elements that are displayed on the user interface. Also at step 1218, the system may additionally provide an option for the user to configure the monitoring settings for the server. For example, the system may display one or more graphical elements that allow the user to enter the vendor or provider information, add a nickname for the server, or specify parameters for use during the remote monitoring and management of the server. The parameters may include options for the user to specify the port and URL information, or specify the monitoring thresholds for CPU usage, memory usage, and hard drive usage, among others, that the system will use to display the content on the graphical user interface, as described further in connection with FIGS. 1-11.

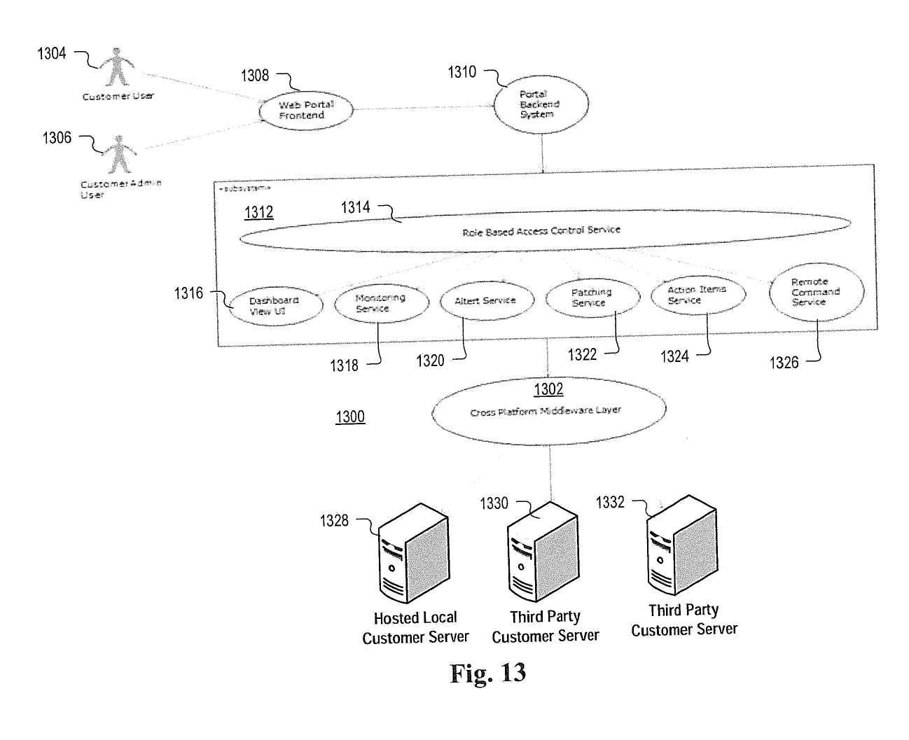

Referring now to FIG. 13, a block diagram of an exemplary network environment in which the remote monitoring and management system operates is shown. In the embodiment shown in FIG. 13, a cloud based remote monitoring and management system 1300 is shown with a cross platform middleware layer 1302. A customer user 1304 or a customer admin user 1306 accesses this system via the web portal front-end 1308, such as by using a web browser to connect to publically accessible website. The web portal front-end 1308 is operative communication with the portal back-end system 1310. In some embodiments, the back-end system 1310 may communicate with a subsystem 1312 in order perform certain functions, such as those described in connection with FIGS. 1-12. The subsystem 1312 may include a RBAC service 1314 to determine what resources/functionality are made available to the user. Additionally, the portal back-end 1310 may also utilize the subsystem 1312 and RBAC service 1314 to implement many of the services described in connection with FIGS. 1-12, such as the dashboard user interface functionality 1316, monitoring service 1318, alert service 1320, patching service 1322, action items service 1324, and remote command service 1326.

The back-end system then communicates with the cross platform middleware layer 1302, which, in certain embodiments, automatically detects the host's operating system, server application type, and other information it needs to run on local servers 1328 and remote third party servers 1330 and 1332. Beneficially, the cross platform layer 1302 allows the monitoring platform to run on servers at different locations, from different providers, using different operating systems, and using different server applications.

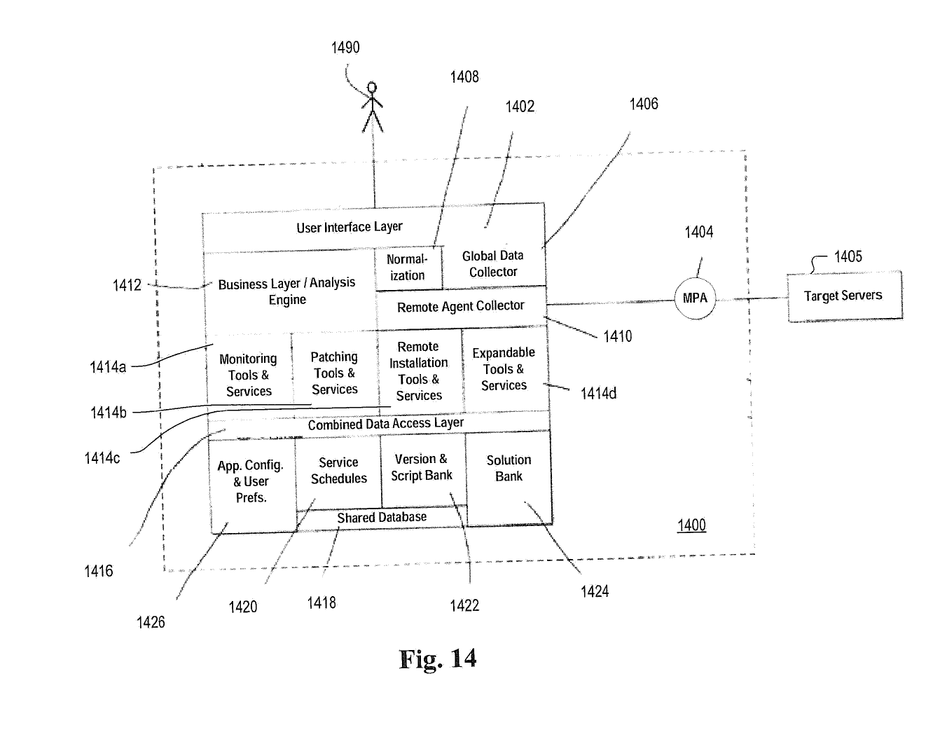

Referring now to FIG. 14, a block diagram of an exemplary embodiment of the artificially intelligent (AI) environment in which the remote monitoring and management system operates is shown. The embodiment shown in FIG. 14 depicts AI platform 1400 as implement various features and services. In one aspect, AI platform 1400 includes a user interface layer 1402 that may include dashboards and other features shown in FIGS. 1-11 and described elsewhere herein, as well as a MPA (Monitoring and Patching Agent) 1404 that interacts with various targets of the patching and server processes described herein, such as target servers 1405. AI platform 1400 further includes a Global Data Collector (GDC) 1406 that collects and stores data from any server and from any customer that uses a portion of the AI platform 1400, such as user interface layer 1402. The global data collector 1406 collects a variety of data, including, but not limited to, FTP connection data and file transmittal logs, application crash reports, and application transaction logs generated during the use of the system. Additionally, the AI platform 1400 may receive a variety of data from additional external sources through its global data collector 1406. In particular, various third party applications can report data to the AI platform 1400 and this data will be collected by the global data collector 1406 for use by the system. The third party applications may report various types of data, such as data from event log manager applications, logs from an enterprise resource planning (ERP) system, transaction logs from a file transfer protocol (FTP) system, and service logs from a communications server, such as a Voice Over Internet Protocol system (VOIP). As will be apparent to one of ordinary skill in the art, these data sources are exemplary and non-limiting, additional data may be collected and processed by the system without departing from the spirit and scope of the present disclosure.

In some embodiments, a normalization feature 1408 normalizes all of the data collected by data collector 1406 in to a common format considering that the collected data may come from a variety of different servers having different configurations and applications and which may be managed by different entities. Additionally, a remote agent connector 1410 collects information from one or more MPAs 1404. Business layer analysis engine 1412 analyzes the collected normalized data as well as data coming from the Remote Agent Connector 1410 to support the system functionality, such as determining how servers having particular operating systems and server configurations are being affected a particular patch or update. AI platform 1400 further includes one or more monitoring or patching tools such as the monitoring tools and services 1414a, patching tools and services 1414b, remote installation tools and services 1414c, and additional expandable space 1414d for installation of additional tools that may be customized to the particular application. The combined data access layer 1416 combines stored data from these different sources, as well as global data collector 1406 and normalizer 1408, making it available for the user 1490 through the functions of AI platform 100. A shared database 1418 receives and stores the data from the combined data access layer 1416 and may also store or interface with additional data sources, such as service schedules 1420 and a trusted software repository with various softer versions (and patches) and installation scripts 1422 that allow the system to install the software version and patches on a wide variety of server configuration. Additionally, shared database 1418 may also store data for or interface with solution bank 1424 that contains a reference database. Solution bank 1424 is a shared database that allows the AI 1400 to access data from a variety of different customers having a variety of different servers. AI platform 1400 can further include an application configuration and user preferences database 1426 that stores configuration information for the various servers as well as a variety of preferences, such user profiles, user roles, RBAC data, dashboard layout, monitoring thresholds, or alerting preferences.

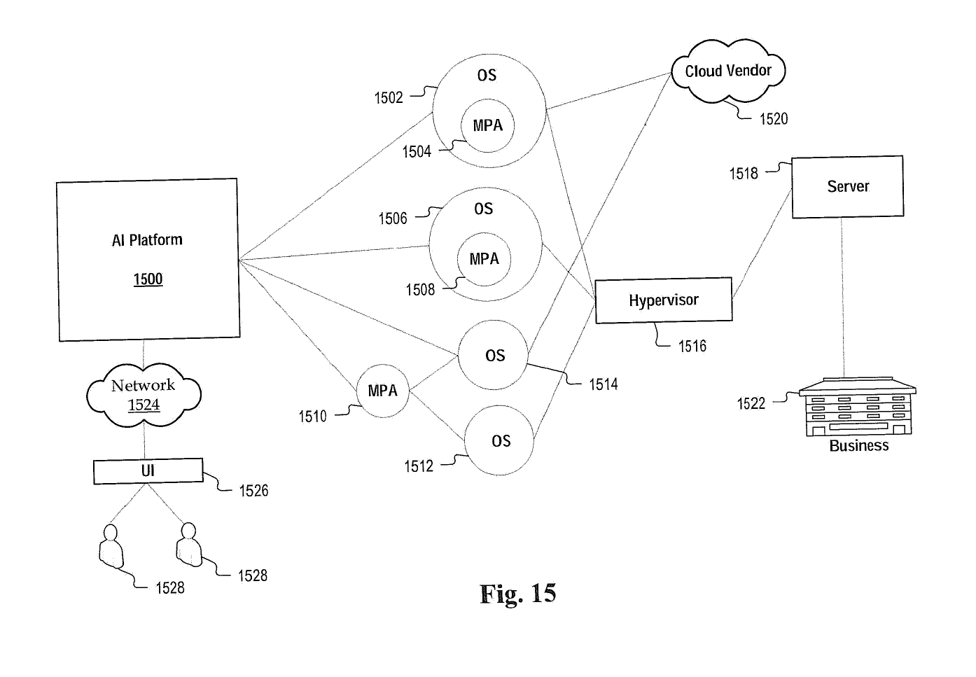

Referring now to FIG. 15, a block diagram of an exemplary embodiment of the AI environment for deploying MPAs. As shown in FIG. 15, the MPAs connect to the AI platform 1500, such as through the AI platform's Remote Agent Connector 1410 discussed in connection with FIG. 15. In some embodiments, each MPA may include a monitoring subsystem and/or a patching subsystem that support the functionality described in connection with FIGS. 1-11. The monitoring subsystem monitors day-to-day operations, such as patching processes, software or firmware updates, and system roll-backs. The monitoring subsystem also monitors important attributes about those servers in order to determine how the servers performing (e.g., CPU and memory status) irrespective of the particular operating system on the particular servers. In this way, the monitoring subsystem can identify failed and/or underperforming servers. For example, the system circuitry can continuously monitor performance measurements for the managed servers (such as the CPU usage, RAM, and storage details) and display alerts or notifications for when one of these performance measurements has reached a critical level or is outside of a threshold specified by the system user during set-up. The patching subsystems of each MPA are used by the AI platform 1500 to remotely apply patches and software updates to the servers even though each server that a respective MPA is running on may have distinct operating systems and may be located at different geographic location.

In one or more embodiments, one or more MPAs may be installed directly on a set of target servers. For example, as shown in FIG. 15, the AI platform 1500 may interface with one or more virtual servers and a separate MPA 1504 and MPA 1508 may be installed on the respective operating systems 1502, 1506 of the virtual servers. The virtual servers may be implemented by one or more hypervisors 1516, and the MPAs may be a directly embedded component of a hypervisor. As will be apparent to one of skill in the art, hypervisors 1516 may be a virtual operating platform run on a host machine (such as physical server 1518) by computer software, firmware or hardware that creates and runs virtual machines. In some embodiments, MPA 1510 may be a standalone application that interfaces with multiple operating systems 1512, 1514 on multiple virtual and/or physical servers. This approach may be beneficial, for example, if the virtual or physical servers share similar configurations or applications, and run similar processes. In this way, a single MPA instance 1510 can monitor and manage both operating systems 1512, 1514. Similarly, although not shown, the MPA 1510 may be directly connected to hypervisor 1516. In this case, the MPA 1510 is not embedded within the hypervisor but is in operable communication with the hypervisor accesses the server information (states, performance, configuration, etc.) from the hypervisor, such as a through a network or interface.

In another embodiment, one or more MPAs may be installed directly on the operating systems running on one or more physical servers, such as physical server 1518 without the use of a hypervisor or virtual server. MPAs may also be installed on operating systems running on a virtual server provided by a variety of possible cloud computing vendor 1520. Cloud computing vendor 1520 may include companies, such as SINGLEHOP® or other providers, and the MPAs may accesses and controls virtual servers and their associated operating systems provided by cloud computing vendor 1520 through the MPA's direct connection to the cloud computing vendor 1520. During the configuration process of the MPA in this style of deployment, a user specifies the cloud computing vendor 1520 that is being used, and supplies the associated user name and password necessary to access the cloud computing vendor 1520, thereby allowing an instance of the MPA access to virtual servers and their operating systems that the cloud computing vendor provides.

As can be seen with reference to FIG. 15, the physical servers 1518 may also be deployed on-site at a place of business 1522. The physical servers located at the place of business 1522 may include servers running a hypervisor with one or more instances of virtual servers, each containing an installation of the MPA on the virtual server's operating system or the physical servers may have an installation of the MPA directly on their operating system. In some embodiments, the physical servers may be stored at a data center and the place of business 1522 may access the data center resources through a network. As will be apparent to one of ordinary skill in the art from the present description, there are a number of possible deployment configurations for deploying the MPA and certain embodiments may use one or more of the deployment configurations depending on the needs of the system and the types of managed servers.

As also shown in FIG. 15, the various MPA instances connect and communicate with the AI platform 1500, and the AI platform uses the MPA instances to monitor and manage the status and performance of each server in the system. In some embodiments, the AI platform 1500 may be also be implemented as a multi-tenant SAAS (Software As A Service) product hosted and serviced by a cloud computing vendor, such as SINGLEHOP®. Users 1528 access the services offered by the AI platform 1500 through a network 1524, such as the Internet, in order to monitor and control the multiple operating system environments that the MPAs are running on. The user 1528 may utilize the AI platform to issue commands, scripts, and queries affecting the operating systems environments through a single user interface 1526 provided by AI platform 1500, such as the interfaces shown and described in connection with FIGS. 1-11. Beneficially, the user 1528 may utilize the UI 1526 to issue a single command, script, and/or query that affects several operating systems environments running instances of the MPA in way that allows the user to easily and efficiently monitor and manage a wide variety of server configurations.

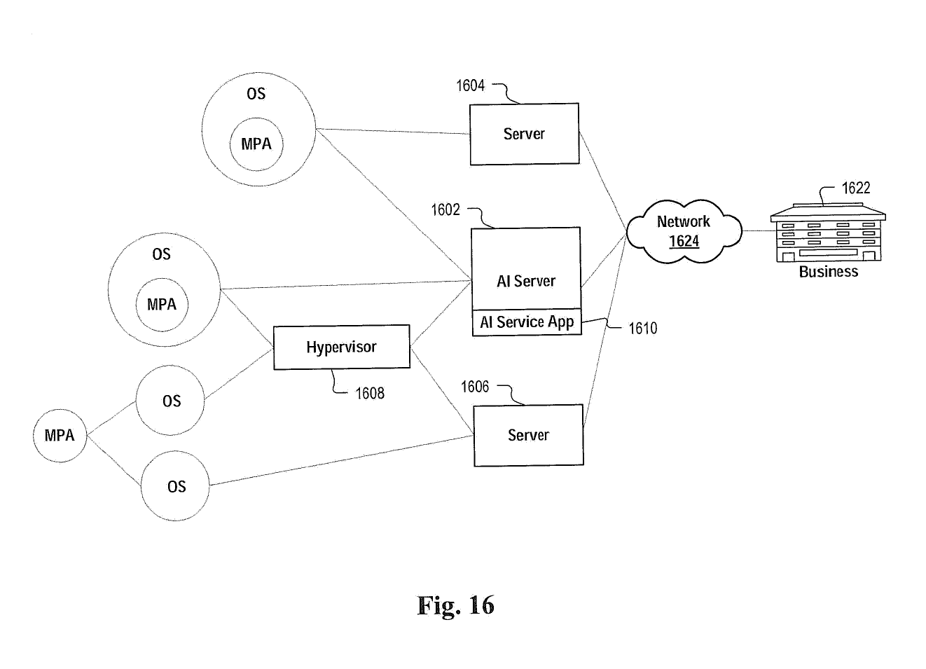

Referring now to FIG. 16, a block diagram of an exemplary embodiment of the AI environment for deploying a dedicated a server at a place of business is shown. In the embodiment shown in FIG. 16, the AI platform is deployed on a dedicated application server 1602 running an AI instance at a place of business 1622. In this embodiment, the dedicated application server 1602 communicates with other servers 1604, 1606 over a network 1624. This allows the dedicated application server 1602 to thereby access other physical servers 1604, virtual servers 1606, as well as hypervisors 1608, and their associated operating systems, which may be arranged as further described in connection with FIG. 15.

In an additional embodiment, the application server 1602 may not be specifically dedicated to the AI platform and the AI platform may be running on the application server 1602 as part of AI service application 1610 on the application server 1602. In either scenario, the application server 1602 and/or AI service application 1610 can be connected to the network 1624 in order to access other servers, such as database servers (not shown) or servers 1604, 1606. Any MPA installed on the operating system of such servers may likewise communicate with the application server 1602 and/or AI service application 1610 in a similar fashion.

Referring now to FIG. 17, a block diagram of an exemplary embodiment of the AI environment for monitoring and managing servers in an artificially intelligent manner is shown. In the embodiment shown in FIG. 17, the AI platform 1700 monitors and manages a number of servers 1710, which may be physical servers, virtual servers running on a hypervisor 1712 (as shown in FIG. 17), virtual servers running directly a physical server's OS, or any of the other configurations described further in connection with FIG. 15. The AI platform 1700 may interface with one or more MPAs 1704, 1708 that are installed the respective operating systems 1702, 1704 of the virtual servers over a network 1714, such as the Internet. The AI platform 1700 issues commands to the MPAs 1704, 1708 via network 1714 and also receives information from the MPAs 1704, 1708 regarding system performance measurements and any other detected errors in server performance. The AI platform 1700 continuously executes a process or routine 1716 that monitors for performance issues (such as servers falling below a set threshold for CPU or RAM performance) and any other errors, such as system failure. Although depicted in FIG. 17 as block diagrams running outside of AI platform 1700, the process or routine 1716 is functionality that may be implemented by one or more by one or more processors or circuit components of one or more distributed computers, servers, or databases, that, in conjunction, make up AI platform 1700.

During normal operation, the process or routine 1716 continuously detects whether a problem or error has occurred at block 1718. If no problem is sensed at block 1718, the AI platform 1700 continues executing the process or routine 1716 as part of its monitoring duties. Upon detection of a problem with one of the servers at block 1718, the AI platform 1700 may respond in a number of ways, such as by preparing an alert message 1720 and a recommended action 1722. For the recommended action 1722, the AI platform 1700 retrieve and analyze data from one of the sources described further in connection with FIG. 14, such as solution bank 1424 (not pictured) or shared database 1418 (not pictured). In particular, the AI platform 1700 receives system status information from MPAs 1704, 1708 installed on operating systems 1702, 1706 through the network 1714 and processes this information to determine what data or what solution from the solution bank from to display as part of the alert message 1720 and recommended action 1722. Once constructed, the alert message 1720 and recommended action 1722 are displayed on a user interface 1728 that allows the user 1730 to access system information through a network 1727. The user may utilize the interface to perform a number of actions, such as applying the recommended action 1722 as suggested by AI platform 1700, scheduling the recommended action to be applied at a later time, silencing or ignoring the alarm (alert) so that the user 1730 may address the problem manually, or assigning the problem to particular employee or expert technician to address. The expert technicians may be employees of the company or third-party technicians, such as contract employees, managed service providers, expert consultants, or others. In some embodiments, the AI platform 1700 may make intelligent recommendations of the employee or technician to use to resolve a problem. For example, one or more system databases (such as application configurations and user preferences database 1426 or shared database 1418 described in connection with FIG. 14) may store profiles for different users that contain data relating to the users' geographic location, their company role, and their varying levels of expertise with particular server issues and/or the unique characteristics and state of a respective server to create a talent database. The system may also track activity of users that have previously solved issues and store this information in the user profile as well. AI platform 1700 utilizes this information to make intelligent recommendations regarding which users are best suited to the fix particular problems based on factors such as a user's expertise, prior tasks solved, or their familiarity with a particular server configuration, such as its operating system or whether the server is on premise, co-located, hosted, bare metal, virtual, or cloud based. The AI platform 1700 compares the recommended action 1722 with its talent database as maintained within its solution bank and ranks a predetermined number of technicians that are able to handle the recommended action 1722 from best to least fit using, for example, regression analysis.

When user 1730 chooses to delegate the alert and recommended action to an employee or technician, the system sends an alert to the interface of the employee or technician, making the employee or technician aware of the problem. The alert message may include specific information such as applications installed, version numbers, specific processes running or stopped, the general number of processes running or stopped, and other information which may be valuable to the technician or employee. After receipt, the technician logs in to AI platform 1700 using the user interface 1702 and may apply the recommended action, or use the interface 1702 to access system tools for developing an independent assessment or an action plan, and apply that plan to the operating systems 1702,1706 using the MPA 1704, 1708. The user may also utilize the interface to perform any of the other features described in connection with FIGS. 1-11, as may be necessary to address the issue. If user 1730 (which may the employee or third party technician) chooses to apply a recommended action, AI platform 1700 will use its patching tools and services and remote installation tools and services to have MPA s 1704, 1708 execute the appropriate commands on the operating systems 1702, 1706 as necessary.

In some embodiments, the process or routine 1716 may include additional step at block 1724 for automatically applying the recommended action. This additional sequence allows the AI platform 1700 to revitalize underperforming or failed servers by performing actions, such as applying patches, reversing patches, updating software, scheduling server maintenance, etc. For most issues, the AI platform 1700 may take actions automatically apply an AI-determined solution to one or more operating systems 1702, 1706 without intervention from the user 1730. The MPAs 1704, 1708 continuously monitor system conditions and provide real-time updates to the AI platform 1700 of system performance and other measurements. The AI platform 1700 then analyzes this data and cross-references it against normalized data from the global data collector to determine what the likely cause of the problem is. For example, the AI platform 1700 may determine that the system has been underperforming since a recent patch or software upgrade was applied, and the AI platform 1700 may determine that a significant percentage of all managed servers that have a similar configuration had similar performance issues after the patch. From this data, the AI platform 1700 can prepare an alert and recommended action of reversing the patch, and in some embodiment, the system may automatically use its patching tools and services and remote installation tools and services to reverse the patch on the affect operating systems. Beneficially, in some instances, no interaction or intervention is required by the user 1730 for AI platform 1700 to resolve a problem which may have been sensed on operating systems 1702, 1706.

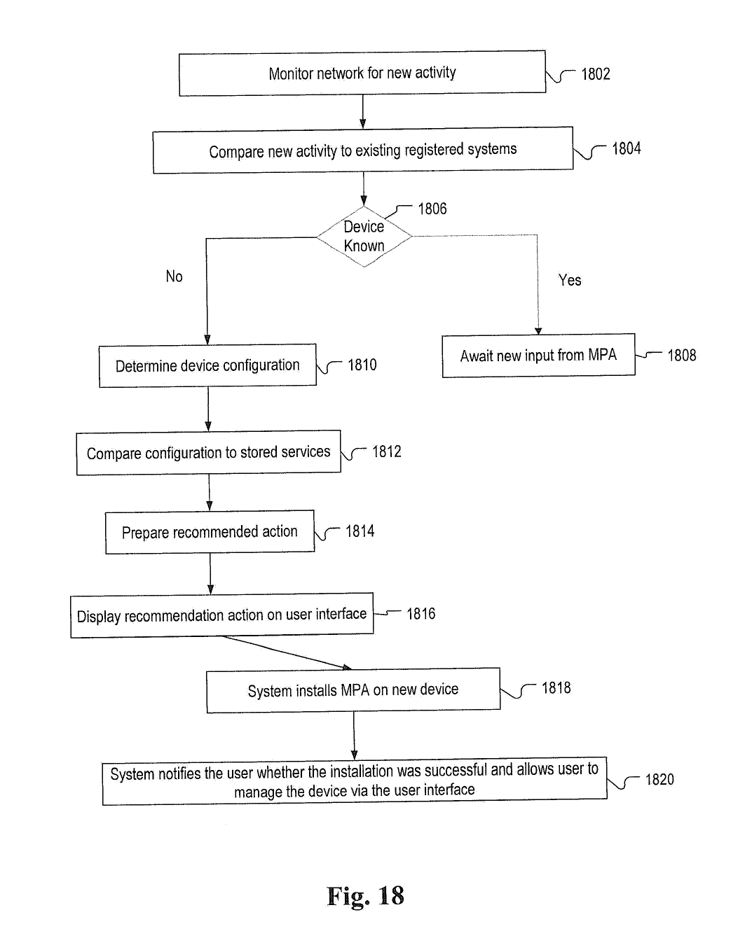

Referring now to FIG. 18, a flowchart illustrating an exemplary system and method for detecting and enrolling new servers and operating systems to be monitored and managed by the system is shown. At step 1802, the AI platform monitors the network for new activity. In some embodiments, the AI platform itself may scan the network using a number of different techniques to discover new services on the network, such as pinging internet protocol (IP) addresses that are active and in range on the network to determine device status, listening at one or more server ports for new activity, discovering devices using a software service, such as BONJOUR®, ISTUMBLER®, or ZEROCONF NEIGHBORHOOD EXPLORER®, reading a network directory service, such as by using Lightweight Directory Access Protocol, and so forth. As will be apparent to one of ordinary skill in the art, these techniques are exemplary and non-limiting, and additional techniques may be used by system without departing from the spirit and scope of the present disclosure. In other embodiments, the distributed nature of the network environment may make it difficult for the AI platform itself to monitor and discovery new devices. In such instances, the AI platform may utilize one or more of the MPAs that are connected to the AI platform to perform similar scanning techniques to discover new services on the network that the MPA is running on. In additional embodiments, the system may utilize a hardware discovery tool that embodies many of the same scanning features of the MPA. The hardware discovery tool need not be installed on a particular operating system and may be a component of the local area network (LAN). Beneficially, these options may be used exclusively or in conjunction and provide the system versatility to adapt to and monitor a wide range of network environments and system configurations.

At block 1804, when the AI platform or MPA discovers new devices, the system will compare the new activity to known devices registered with the system to determine if the devices are servers and operating systems that are not yet enrolled with the AI platform and are therefore candidates for enrollment. If the device reported by the AI platform or MPA is already known (e.g., it's IP address and server configuration data matches the stored data for known device), then at block 1808 AI platform will perform its normal operation activity and await for any new input from the MPA related to performance or management issues. If the device reported by the AI platform or MPA is not known by the system, then system proceeds to block 1810 to begin the process for determine whether the device may be registered with the system as a new device to monitored and managed. At block 1810, the system issues a number of commands or pings to the device to determine device configuration. At block 1814, the system compares the device configuration to the store data for other devices having a similar configuration to determine, for example, if the system can support the new device. The system may identify currently enrolled devices having similar configurations so that it may present recommended actions to the user on how to configure the new device. At block 1814, the system prepares the recommended actions to the user. In some embodiments, the system may use the known devices having a similar configuration to the new device as a sample set, and determine which configurations within the sample set have the best performance metrics. In this way, the system can make intelligent recommendations to the user based on the stored performance data for managed devices.

At block 1816, the system may display the recommended action on the user interface for the administrator of the network where the new device was discovered. The administrator may review the suggested network configurations and make any modifications. At block 1818, the system installs a new instance of the MPA on the device so that the AI platform or connects the new device to an existing instance of a MPA so that system may monitor the new device and manage its activity. At block 1820, the system notifies the user whether the installation was successful and allows the user to manage the device using the system interface described further in connection with FIGS. 1-12. For example, the user can view performance data, set thresholds for alerts, remotely configure the device settings, and so forth.

Referring now to FIG. 19, a flowchart illustrating an exemplary system and method for installing MPAs on an operating system using an enhanced one-line-command installation process is shown. The process shown in FIG. 19 allows the system to remotely utilize a light-weight installation program and configure the light-weight installer to account for particular configuration settings the target server, as well as any other environment-specific variables. This results in significant reduction to any need for manual or technician intervention. At block 1902, a user utilizes the system interface to enter a command line installation script for installing a MPA on a target server, as described further in connection with FIG. 7. At block 1904, the install script is assigned to a light-weight installer that will complete the installation remotely by communicating with the AI platform over the network. At block 1906, the light-weight installer launches locally on the target server's operating system. At block 1908, the light-weight installer collects information about the target server's environment (such as operating system and network configurations). At block 1912, the light-weight installer generates an information package that contains all of the data relating to the target server's operating environment and transmits this information to the AI platform over the network.

At block 1912, the AI platform receives the information package from the light-weight installer and compares the target server's environment attributes to one or more databases managed by the AI platform described further in connection with FIG. 14, such as the version and script bank 1422 or the solution bank 1424. At block 1914, the AI platform determines the particular configuration settings that match the target server's environmental data and that have the best performance metrics. The AI platform creates a configuration file from these settings and transmits the configuration file back to the light-weight installer at block 1916. At block 1918, the light-weight installer receives the configuration file, sets local installation parameters according to those specified by the AI platform and completes the installation of the MPA 104.

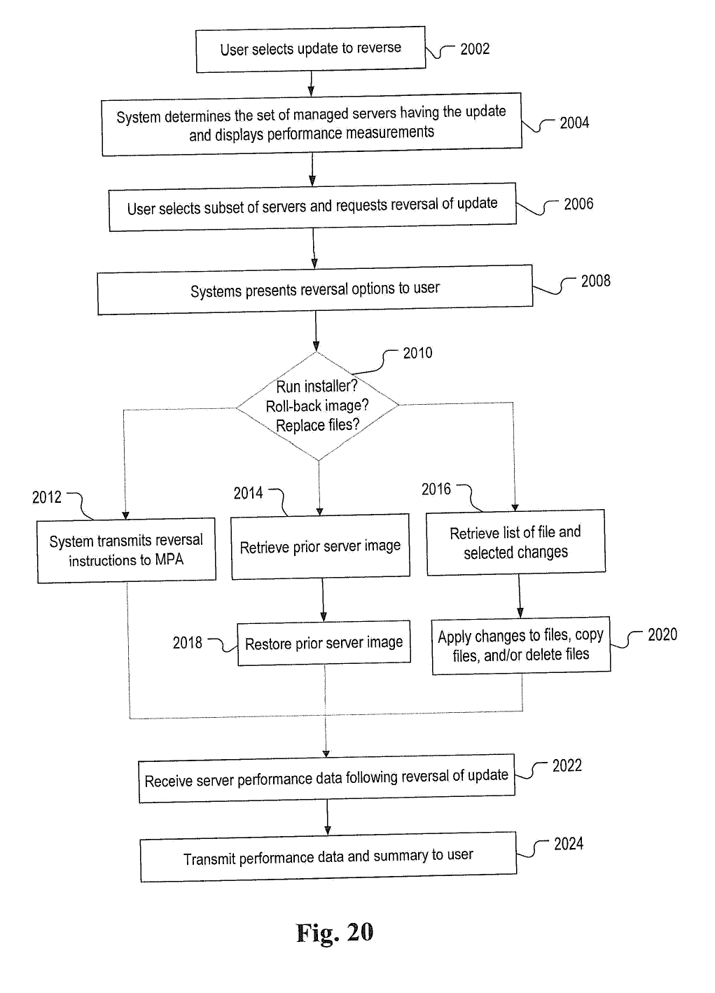

Referring now to FIG. 20, a flowchart illustrating an exemplary system and method for reversing patch or software updates is shown. In some embodiments, the system and method steps shown in FIG. 20 may be utilized by the AI platform to reverse previously applied server updates, such as reversing patches, restoring prior server images, replacing individual files that were modified at the time of a software update, or reversing any other action which may have been applied by a system user to one of the operating systems that running an instance of the MPA. This is feature particularly beneficial because the system allows the user to remotely manage and monitor a number of servers having differing configurations and the user may have applied the same software update to all of the servers. The AI platform monitors the processes running on each of those servers and may alert the user when a particular process is causing negative effects to the server operation. If the aforementioned AI platform functionality determines that the software update is adversely affecting a particular set of servers having certain configurations, then the user can utilize this tool to target those servers having negatively impacted performance measurements.

As explained further in connection with FIGS. 1-11, the user may be utilize the system interface to monitor the performance of a particular server or a set of servers and set threshold alerts for issues such as CPU and RAM usage. At step 2002, the user, having viewed or monitored the performance data or received alerts for particular servers and processes running on those servers, utilizes the system interface to select an update to reverse. At step 2004, the system determines the set of managed servers that have the selected update and displays the list of servers along with performance measurements for each server, such as shown and described in connection with FIGS. 1-4. At step 2006, the user selects a subset of the servers from the list, confirms the update to reversed, and requests reversal of the update. In some embodiments, the system may automatically execute a process to reverse the update. Depending on the nature of the update, the process may also include step 2008 where the system presents the user with options for reversal, including, but not limited to, reversing the update using an uninstaller, rolling back the server to a stored image before the update was applied, or replacing particular files associated with the update. At step 2010, the system determines what actions were selected by the user and initiates the appropriate processes. For example, if the user selected the option to reverse the update using the installer, then they system will proceed to step 2012 and transmit a instructions or a light-weight uninstaller having the correct configurations to the MPA running the operating system of the selected server. If the user selects the option to restore a prior server image, then the system will retrieve a list of prior images at step 2014 (which may be stored on the AI platform or on the operating system of the server and retrieved from the corresponding MPA) and allow the user to confirm which image to restore. At step 2018, the system transmits instructions to the MPA, including, if necessary, the selected server image, and the MPA restores the prior server image. If the user selects the option to replace or alter particular files, then system proceeds to step 2016 and retrieves a list of files that were affected by a prior update and allows the users to select which modifications to make to the files. At step 2020, the system transmits the instructions to the local MPA to apply the selected changes to the files, which may include, for example, deleting files which were written during the time the update was installed, replacing files modified by the update process with copies of files existing prior to the time the update was installed, or altering particular files by applying a new patch that reverses the negative effects of the prior patch or update.

At step 2022, the system receives server performance data for the targeted servers following the reversal of the update. At step 2024, the system transmits a log to the user containing the updated performance data and summary information regarding the reversal process and errors that may have occurred. Although the functions described in connection with steps 2002 through 2024 are depicted sequentially using distinct path flows, it will be apparent to one of skill in the art, that the order may be varied, one or more pathways may be combined, or additional steps may take place without departing from spirit and scope of the present disclosure, as the user may utilize the system interface to track server performance using a wide range of monitoring and managing features.

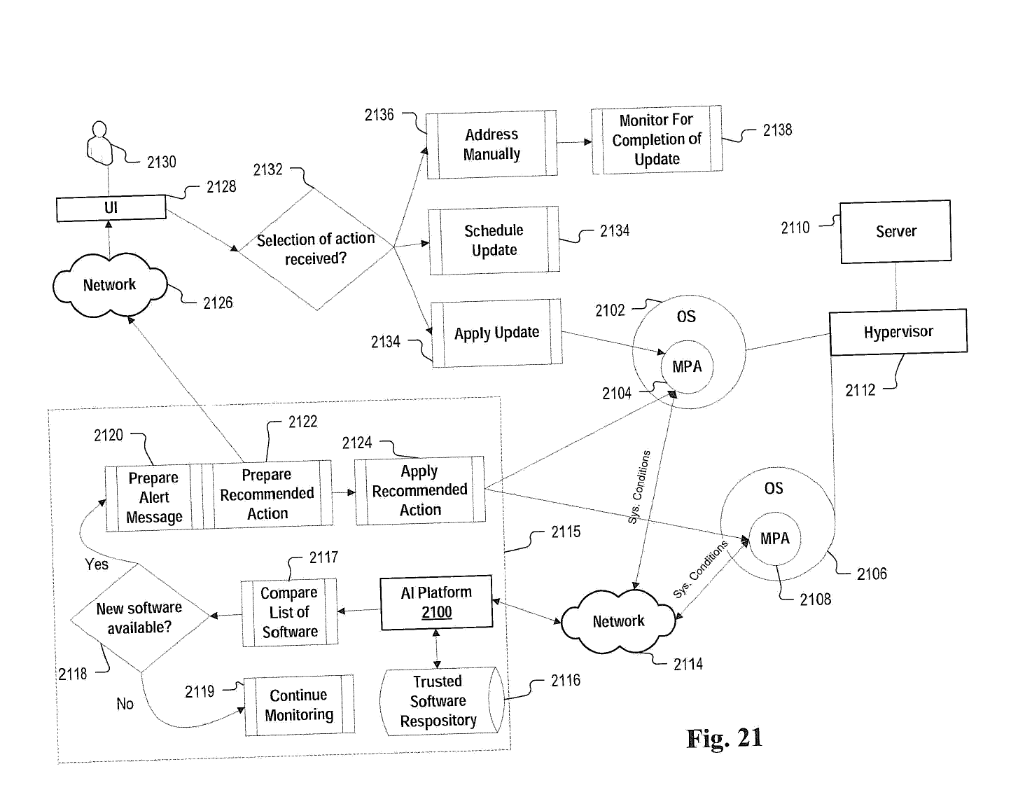

Referring now to FIG. 21, a block diagram of an exemplary embodiment of the AI environment for detecting new software updates and intelligently applying patches is shown. In the embodiment shown in FIG. 21, the AI platform 2100 monitors and manages a number of servers 2110, which may be physical servers, virtual servers running on a hypervisor 1712 (as shown in FIG. 21), virtual servers running directly a physical server's OS, or any of the other configurations described further in connection with FIG. 15. The AI platform 2100 interfaces with one or more MPAs 2104, 2108 that are installed the respective operating systems 2102, 2106 of the virtual servers over a network 2114, such as the Internet. The AI platform 2100 issues commands to the MPAs 2104, 2108 via network 2114 and also receives information from the MPAs 2104, 2108 regarding system performance measurements and any other detected errors in server performance. The AI platform 2100 continuously executes a process or routine (depicted in FIG. 21 by the components and sub-processes within element 2115) that monitors for new system updates, such as software updates or patches. Although the AI platform is shown in FIG. 21 within element 2115, it will be apparent to one skill in the art that each of the processes and sub-processes illustrated in FIG. 21 may be implemented by one or more by one or more processors or circuit components of one or more distributed computers, servers, or databases, that, in conjunction, make up AI platform 2100.

In practice, MPAs 2104, 2108 detect and collect data related to installed applications and corresponding version numbers running on operating systems 2102, 2106. MPAs 2104, 2108 transmit this data to AI platform 2100 continuously or on a configurable interval. The AI platform 2100 receives this data and executes a sub-process 2117 to compare the received list of applications and version numbers to the latest application version numbers, which may be stored in the trusted software repository 2116 and accessed by the AI platform 2100 circuitry. The system determines whether new software is available from the trusted software repository 2116 at block 2118. If the data for the applications and corresponding version numbers running on operating systems 2102, 2106 is up to date, then the system continues to execute the sub-process 2119 for monitoring incoming data. If the system determines that new software updates for the operating systems 2102, 2106 are available, then the system proceeds to sub-processes 2120 and 2122 to prepare an alert message and a recommended action. In some embodiments, the system may automatically apply the recommended action to update the server without requiring any human intervention. For example, if the system determines that software available in its trusted software repository 2116 is a routine or critical update, then the system may proceed to transfer the updates to the MPAs 2104, 2108, so that MPAs 2104, 2108 can install the software updates on operating systems 2102, 2106.

In other embodiments, the system may execute the sub-processes 2120, 2122 to construct an alert message and recommended action describing the update that is available and transmit the message through network 2126, so that the message content can be displayed to the user 2130 on the user interface 2128. The user 2130 may utilize the interface 2128 to view the alert message and recommended actions and perform a number of actions, such as applying the recommended action (e.g., applying the new software update or patch) as suggested by AI platform 2100, scheduling the recommended action to be applied at a later time, r silencing or ignoring the alarm (alert) so that the user 2130 may address the problem manually or assign the problem to particular employee or expert technician to address, as described further in connection with FIG. 17. At block 2132, the system receives a selection of an action by the user and determines what sub-process to execute. If the user has selected the option for applying the update, then the system sends the update to the local MPA 2104 at block 2134 with the necessary installer and configuration file so that the MPA can update the corresponding operating system 2102. If the user has selected to schedule an update, the system schedules the update for a later time at block 2134. The system may automatically apply the update at the scheduled time or issue another alert to the user that the update is ready. If the user selects the option to apply the update manually, then the system proceeds to block 2136 where the alert is silenced for time being and the system executes a sub-process 2138 to monitor the corresponding operating system for when the update has been completed. For example, the system may issue a command to the local MPA 2104 to check whether the corresponding operating system 2102 has been updated or the issue has been resolved.

Although certain embodiments may refer to similar features or components by varying element numbers, as will be apparent to one of ordinary skill in the art, these features or components are not mutually exclusive and may be the same component. Thus, one of ordinary skill in the art will understand that applications in accordance with the present description may include one or more of the features, apparatuses, and systems described in connection with each of the various embodiments described herein. Moreover, each embodiment can broadly include a variety of electronic and computer systems. In particular, each and every operation described herein may implemented by corresponding hardware and circuitry. For example, each and every operation may have its own dedicated circuitry, such as may be implemented using a programmable logic array (PLA), application-specific integrated circuit (ASIC), or one or more programmed microprocessors. In some embodiments, each of the operation may be performed by system logic that may include a software controlled microprocessor, discrete logic, such as an ASIC, a programmable/programmed logic device, memory device containing instructions, a combinational logic embodied in hardware, or any combination thereof. Accordingly, logic may be fully embodied as software, firmware, or hardware. Other embodiments may utilize computer programs, instructions, or software code stored on a non-transitory computer-readable storage medium that runs on one or more processors or system circuitry of one or more distributed servers and databases. Thus, each of the various features of the operations described in connection with the embodiments of FIGS. 1-21 may be implemented by one or more processors or circuit components of one or more distributed computers, servers, or databases, that, in conjunction, are configured to execute instructions to perform the function by executing an algorithm in accordance with any steps, flow diagrams, drawings, illustrations, and corresponding description thereof, described herein.

The aforementioned servers and databases may be implemented through a computing device. A computing device may be capable of sending or receiving signals, such as over a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include a central processing unit and memory. A server may also include a mass storage device, a power supply, wired and wireless network interfaces, input/output interfaces, and/or an operating system, such as WINDOWS SERVER®, MAC OS X®, UNIX®, LINUX®, FREEBSD®, or the like. Devices for accessing the system interfaces may include, for example, a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the foregoing devices, or the like.

As used herein, a network may be a communication link or channel, may include for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example. The network may include wired or wireless networks. A wireless network may couple client devices with a network. A wireless network may employ stand-alone ad-hoc networks, mesh networks, Wireless LAN (WLAN) networks, cellular networks, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

While the computer-readable medium as described or set forth in the appended claim may be described as a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system stored in a non-transitory medium executable by processor circuitry for remotely monitoring and managing servers, the system comprising:
a plurality of servers having a plurality of operating systems;
a plurality of monitoring and patching agents installed on the operating systems of the plurality of servers;
a central platform server in operative communication with the plurality of monitoring and patching agents over a network,
wherein the plurality of monitoring and patching agents are configured to monitor performance data for the plurality of servers and to transmit the data to the central platform server over the network.

2. The system of claim 1, wherein the monitoring and patching agents are configured to receive new software patches from the central platform server and to install the new software patches on the respective operating systems of the plurality of servers.

3. The system of claim 2, wherein the monitoring and patching agents are configured to identify servers that are underperforming in response to the installed new software patches and to transmit identification data for the underperforming servers to the central platform server.

4. The system of claim 3, where the central platform server is further configured to transmit patch reversal software to the monitoring and patching agents associated with the underperforming servers.

5. The system of claim 1, where in the performance data for the plurality of servers comprises at least central processing unit usage and random access memory usage for each server.

6. The system of claim 1, wherein at least two of the plurality of monitoring and patching agent are installed on virtual operating systems.

7. The system of claim 6, wherein the virtual operating systems are running on a hypervisor of a single server.

8. The system of claim 1, wherein at least one monitoring and patching agent is configured to monitor performance data for multiple operating systems and to transmit the data for the multiple operating systems to the central platform server over the network.

9. The system of claim 1, further comprising a display operatively coupled to the central platform server that displays a summary of the performance data for the plurality of servers.

10. The system of claim 9, wherein central platform server is further configured to display alerts on the display when the performance data for a server exceeds predetermined thresholds.

11. The system of claim 1, wherein the central platform server is further configured to automatically discovery new servers that have enrolled with the central platform server and to automatically install a monitoring and patching agent on an operating system associated with each new server.

12. A computer-implemented method for remotely monitoring and managing servers, comprising:
receiving, by one or more processors, performance data for a plurality of operating systems associated with a plurality of servers from a plurality of remote monitoring and patching agents;
identifying, by the one or more processors, at least one operating system running an outdated software process;
transmitting, by the one or more processors, a software patch to the remote monitoring and patching agent associated with the at least one operating system;
receiving, by the one or more processors, a confirmation that the software patch has been installed on the at least one operating system; and
receiving, by the one or more processors, updated performance data for the at least one operating system.

13. The method of claim 12, further comprising displaying the performance data on a graphical user interface.

14. The method of claim 12, further comprising: determining, by the one or more processors, whether the updated performance data for the at least one operating system indicates that the server is underperforming in response to the installation of the software patch.

15. The method of claim 14, further comprising: determining, by the one or more processors, a recommended action in response to the updated performance data indicating that the server is underperforming.

16. The method of claim 15, further comprising: receiving, by the one or more processors, a user selection of whether to apply the recommended action.

17. The method of claim 14, further comprising:
transmitting, by the one or more processors, a patch reversal package to the remote monitoring and patching agent associated with the at least one operating system, and
receiving, by the one or more processors, a confirmation that the patch reversal package has been installed on the at least one operating system.

18. The method of claim 14, further comprising: transmitting, by the one or more processors, an alert to a user when the in response to the updated performance data indicating that the server is underperforming.

19. The method of claim 12, further comprising:
identifying, by the one or more processors, a new server to be monitored and managed;
transmitting, by the one or more processors, an installation package to install a remote monitoring and patching agent on the new server's operating system.

20. A system for remotely monitoring and managing servers, the system comprising:
a means for receiving performance data for plurality of operating systems associated with a plurality of servers;
a means for identifying at least one operating system that is underperforming or running an outdated software process;
a means for transmitting a software patch to the at least one operating system;
a means for receiving a confirmation that the software patch has been installed on the at least one operating system.
